(19) United States
(12) Patent Application Publication
(10) Pub. No.: US 2025/0044397 A1
(43) Pub. Date: Feb. 6, 2025

(54) USE OF AN ULTRA-WIDEBAND (UWB) RADIO IN PLAYBACK DEVICES

(71) Applicant: Sonos Inc., Santa Barbara, CA (US)

(72) Inventors: Kasra PAYANDEHJOO, Santa Barbara, CA (US); Nobuo NAKATA, Santa Barbara, CA (US); Ian FRANK, Santa Barbara, CA (US)

(21) Appl. No.: 18/696,467

(22) PCT Filed: Sep. 29, 2022
(86) PCT No.: PCT/US2022/077240

§ 371 Date: Mar. 28, 2024

Related U.S. Application Data
(60) Provisional application No. 63/250,508, filed on Sep. 30, 2021.
(60) Provisional application No. 63/250,517, filed on Sep. 30, 2021.
(60) Provisional application No. 63/376,871, filed on Sep. 23, 2022.

(51) Int. Cl. G01S 5/02; G01S 5/14; G01S 11/06

(52) U.S. Cl. CPC G01S 5/0284; G01S 5/14; G01S 11/06

(57) ABSTRACT

Embodiments disclosed herein include playback devices with multiple antennas and antenna switching capabilities employed to determine relative locations of other playback devices based on ultra-wideband (UWB) signals transmitted between the devices. In some embodiments, the determination is based on an estimation of angle of arrival of UWB signals received from another playback device. In some embodiments, the determination is based on an estimation of range between antennas of the devices, for example derived from time of flight measurements of the UWB signals received from another playback device. In some embodiments, trilateration techniques are used to determine the relative locations from the estimated ranges. The relative locations are used to assist with installation and setup of the devices in a given environment. After determination of the relative locations, a playback configuration mode can be set for the playback devices to include playback of one or more channels of multi-channel audio content.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 1I illustrates an example communication system that includes example switching circuitry and/or communication circuitry configurations.

FIG. 2A illustrates an example configuration that includes three playback devices.

FIG. 2B illustrates another example configuration that includes three playback devices.

FIG. 3 illustrates an example of angle of arrival (AOA) estimation in accordance with aspects of the disclosed technology.

FIG. 4 illustrates a directional antenna array configured in accordance with aspects of the disclosed technology.

FIG. 5 illustrates an example of time of flight (ToF) estimation in accordance with aspects of the disclosed technology.

FIG. 6 illustrates an example playback device that includes five antennas configured in accordance with aspects of the disclosed technology.

FIG. 7 is a plot of the range estimate confidence versus the number of moving averages that are performed in accordance with aspects of the disclosed technology.

FIG. 8 illustrates a playback device configured to perform ToF/range estimation in accordance with aspects of the disclosed technology.

FIG. 9 illustrates a playback device configured to perform either or both ToF/range estimation and 2-dimensional AOA estimation in accordance with aspects of the disclosed technology.

FIG. 10 illustrates a playback device configured to perform both ToF/range estimation and 3-dimensional AOA estimation in accordance with aspects of the disclosed technology.

FIG. 11A illustrates an example configuration that includes three playback devices.

FIG. 11B illustrates another example configuration that includes a greater number of playback devices.

FIG. 12 illustrates an example playback device that includes three antennas configured to perform time of flight (ToF)/range estimation in accordance with aspects of the disclosed technology.

FIG. 13 illustrates an example of ToF/range estimation in accordance with aspects of the disclosed technology.

FIG. 14 illustrates an example of trilateration in accordance with aspects of the disclosed technology.

FIG. 15 illustrates an example of location disambiguation in accordance with aspects of the disclosed technology.

FIG. 16 illustrates an example of grouping of playback devices in accordance with aspects of the disclosed technology.

FIG. 17 shows an example embodiment of a method for a playback device to discriminate between other playback devices, based on AOA estimation techniques in accordance with aspects of the disclosed technology.

FIG. 18 shows an example embodiment of another method 1200 for a playback device to discriminate between other playback devices, based on ToF estimation techniques in accordance with aspects of the disclosed technology.

FIG. 19 shows an example embodiment of a method for a playback device to determine a location relative to other playback devices, based on ToF estimation techniques, in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Building upon years of experience creating sophisticated, yet easy-to-use, audio products, SONOS Inc. has appreciated that a wide range of audio experiences can be created when playback devices have knowledge of their locations with respect to each other. For instance, the relative location of playback devices may be employed to facilitate tuning of playback devices (e.g., automatically setting/modifying one or more equalization settings based on a distance between playback devices), allocate audio channels to those devices (e.g., automatically discriminating between left and right playback devices during setup of a stereo pair), and/or facilitate playback synchronization between those devices (e.g., automatically grouping proximate playback devices and/or suggesting that those playback devices be grouped).

Accordingly, aspects of the present disclosure relate to techniques for determining the relative location of playback devices in a media playback system and associated example applications of such information that enable improved user experiences. One example application for such relative location information is automatic discrimination between playback devices in a bonded group (e.g., a home theater setup comprising a soundbar and one or more satellites, a stereo pair setup comprising a left player and a right player). The capability to automatically discriminate between any number of playback devices in a bonded group can facilitate the setup process by avoiding the need for users or installers to manually identify the various components. For example, some systems guide the user through a series of steps that require the user to input information indicative of which speaker or playback device is the left or rear left versus the right or rear right. More generally, some systems guide the user through a series of steps that require the user to input information indicative of the relative locations of each speaker or playback device. For instance, an application (or app) may ask the user to push a button on a specific speaker (e.g., left/rear left). In other instances, the app may trigger one of the two speakers to play a sound (e.g., a tone) and request the user to indicate, using the app, whether the sound is coming from the rear left or rear right speaker. Automatic identification of the playback devices and their relative locations can make the setup process smoother and more seamless, reducing the time required for a user to go from opening a box to listening to audio.

Another example application includes facilitating grouping of large deployments of playback devices in a commercial or residential location distributed over multiple departments, regions, and/or rooms. The capability to determine relative locations of playback devices may be employed to automatically suggest (and/or assign) playback devices that are positioned close to each other (e.g., in a room, a department, etc.) to a specific group for synchronous playback. For instance, a user will likely assign playback devices that are clustered together to a common group. Accordingly, a large deployment of playback devices may be more easily grouped by bulk assigning clustered playback devices to a single group instead of assigning each individual playback device to a specific group. As a concrete example, a department store may deploy 100 playback devices across three different departments (e.g., electronics, apparel, and beauty). In such a deployment, the installer may need to add each of those 100 playback devices into one of three synchrony groups corresponding to one of the three departments (e.g., one synchrony group for electronics, one for apparel, and one for beauty). Instead of manually assigning each of the 100 playback devices to a particular synchrony group, clusters of playback devices may be identified (e.g., a cluster of devices in each of three departments) that can be bulk assigned to a specific group. As a result, the setup time for that large deployment of playback devices may be substantially reduced.

To this end, embodiments disclosed herein describe playback devices that leverage ultra-wideband (UWB) technology (e.g., UWB radios, multiple antennas, and switching capabilities) to determine the relative locations of other playback devices. In some embodiments, for example, the determination is based on an estimation of angle of arrival (AOA) of a UWB signal received from another playback device. The AOA is based on a measured phase difference between the signal as received at two of the antennas of the playback device. In some embodiments, the antennas may be directional antennas, such as, for example, patch antennas, and the antennas may be separated by a distance that is less than one half of the wavelength corresponding to the center frequency of the UWB signal. In some embodiments, the antennas may be of the same design/construction, including matching polarization (e.g., both linear or both circular).

In some embodiments, a third antenna may be employed to provide an AOA estimate in another dimension (e.g., a vertical dimension) so that the determined location of the other playback device may include height above ground. In some embodiments, the third antenna may be of the same design/construction and polarization as the other two antennas.

In some embodiments, the determination is based on estimated ranges to the other playback device. The estimated ranges are derived from, for example, ToF of one or more signals received from the other playback device, at two (or more) of the antennas of the playback device. The first of the estimated ranges is between a first antenna of the playback device and a first point on the other playback device and the second of the estimated ranges is between a second antenna of the playback device and a second (different) point on the other playback device. In some embodiments, the relative locations of the other playback devices may then be determined using trilateration, based on the estimated ranges, as described in greater detail below. Additionally (or alternatively), the determination is based on a time difference of arrival of one or more signals received from the other playback device at two antennas of the playback device.

In some embodiments, the antennas may be omnidirectional antennas, such as, for example, monopole antennas. In some embodiments, ToF estimations may be repeated for multiple signal transmissions and the results averaged over time (e.g., using a moving average technique) to decrease measurement error.

Switches may be employed, for example under control of a processor of the playback device, to selectively couple different antennas or groups of antennas to various receive and transmit ports of the UWB radio so that AOA estimation or ToF estimation may be performed.

In some embodiments, after determination of the relative locations of the other playback devices, the relative locations of the other playback devices may be employed to facilitate grouping of playback devices. For instance, playback devices that are positioned within a threshold distance of each other may be automatically grouped together for synchronous playback. In some embodiments, the playback configuration may be set to cause the first playback device to playback of the audio content in synchrony with the second playback device.

Additionally (or alternatively), the relative locations of the other playback devices may be employed to allocate (or otherwise assign) playback of one or more channels of multi-channel audio content. The multi-channel audio content may include stereo content comprising a left channel and a right channel, or a center channel and a rear channel. In some embodiments, the playback configuration may cause playback of the one or more first channels of the multi-channel audio content in synchrony with playback of one or more second channels of the multi-channel audio content by the second playback device.

In some embodiments, the disclosed techniques may be employed to determine the relative locations of any number of additional playback devices and the results can be used to in any of a variety of ways (e.g., to implement additional playback configurations). For example, a home theater system may include many playback devices and each playback device can be configured to play back one or more channels of multi-channel audio content in synchrony with the other playback devices. Additional examples of ways in which the relative location of any number of playback devices may be used include, for example, audio tuning (e.g., setting one or more equalization parameters) and/or placement suggestions for the user (e.g., move playback device A further from playback device B in a stereo pair to improve the quality of the resulting stereo surround).

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

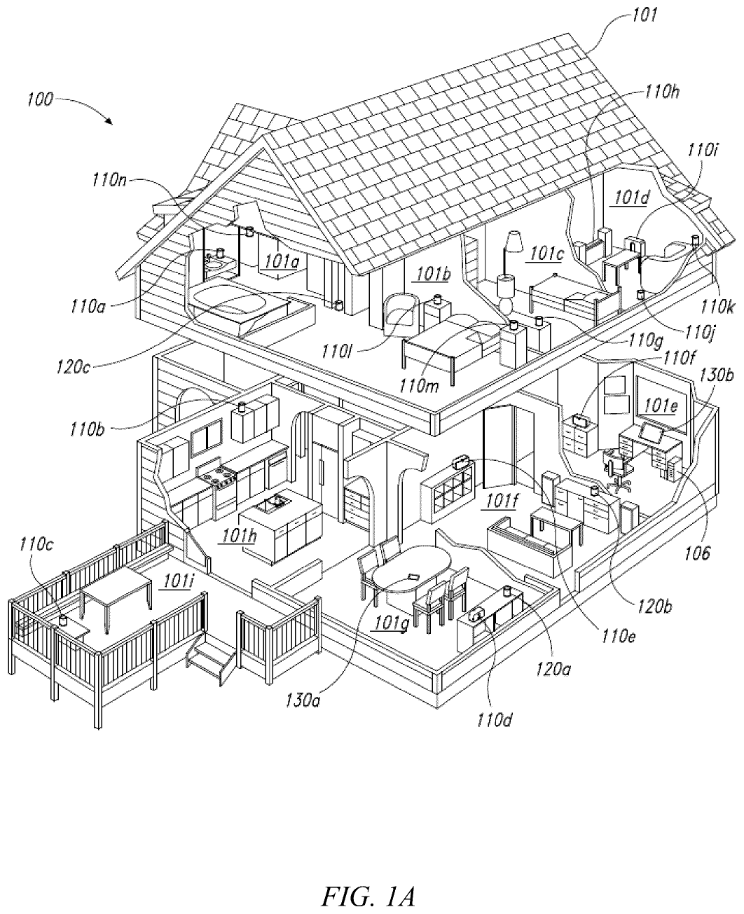

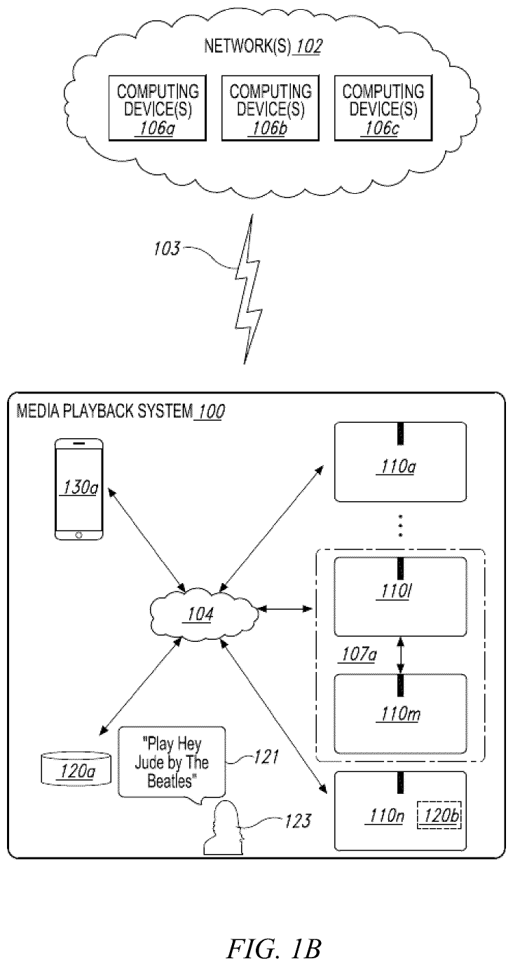

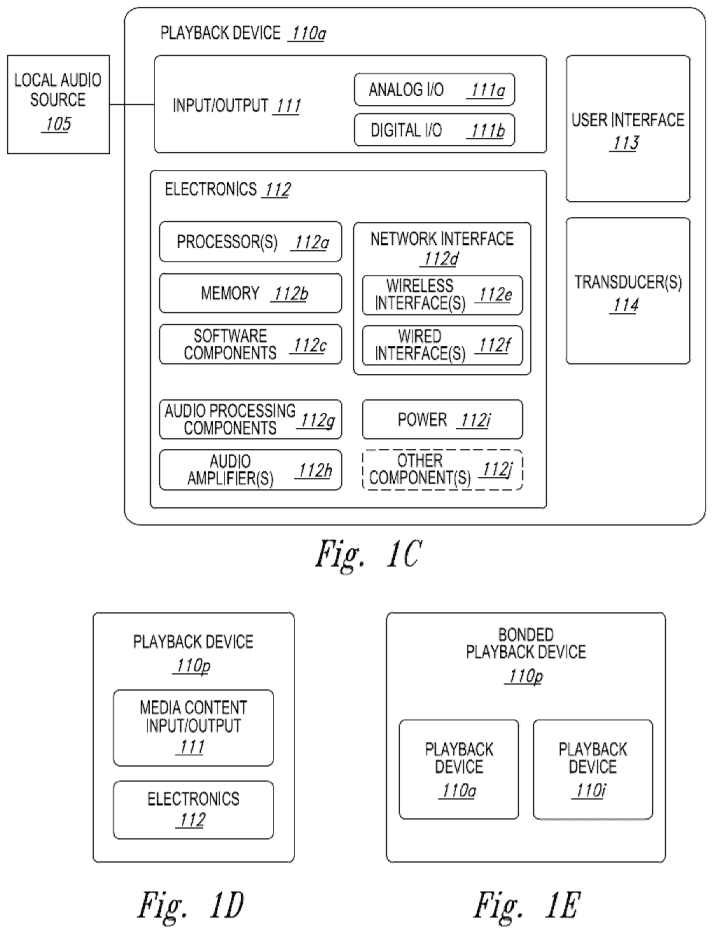

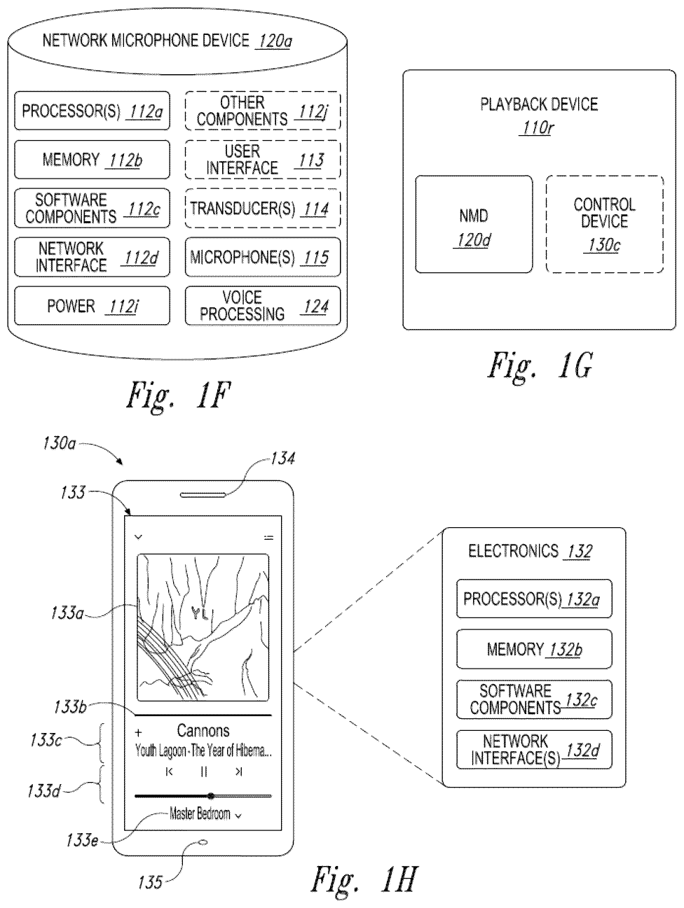

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles, and other features shown in the Figures are merely illustrative of particular embodiments of the disclosed technology. Accordingly, other embodiments can have other details, dimensions, angles, and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices, etc.) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation, etc.). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane, etc.), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication networks, and/or other suitable data transmission protocol networks), etc. The cloud network 102 is configured to deliver media content (e.g., audio content, video content, photographs, social media content, etc.) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household or commercial facility communication network (e.g., a household or commercial facility WiFi network). In some embodiments, the links 103 and the network 104 comprise one or more of the same networks. In some aspects, for example, the links 103 and the network 104 comprise a telecommunication network (e.g., an LTE network, a 5G network, etc.). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud servers that host cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length, etc.) and other associated information (e.g., URIs, URLs, etc.) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®, etc.). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication link. In certain embodiments, the analog I/O 111a and the digital 111b comprise interfaces (e.g., ports, plugs, jacks, etc.) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer, etc.) or another suitable audio component (e.g., a television, a desktop computer, an amplifier, a phonograph, a Blu-ray player, a memory storing digital media files, etc.). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens, etc.), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over-Ethernet (POE) interfaces, and/or other suitable sources of electric power). In some embodiments, the electronics 112 optionally include one or more other components 112j (e.g., one or more sensors, video displays, touchscreens, battery charging bases, etc.).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone, etc.).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds, etc.) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receive and process the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE, etc.). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 exclude the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DACs), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omit the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers 112h include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G amplifiers, class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 include a single one of the amplifiers 112h configured to output amplified audio signals to a plurality of the transducers 114. In some other embodiments, the electronics 112 omit the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skill in the art will appreciate that a playback device is not limited to the examples described herein or to SONOS product offerings. In some embodiments, for example, one or more playback devices 110 comprise wired or wireless headphones (e.g., over-the-ear headphones, on-ear headphones, in-ear earphones, etc.). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing components 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers, etc.).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing components 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input, etc.) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing components 124 receive and analyze the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing components 124 monitor the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone, etc.) on which media playback system controller application software is installed. In some embodiments, the control device 130a comprises, for example, a tablet (e.g., an iPad™), a computer (e.g., a laptop computer, a desktop computer, etc.), and/or another suitable device (e.g., a television, an automobile audio head unit, an IoT device, etc.). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE, etc.). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection, etc.) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos, etc.), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year, etc.) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone “, an Android phone, etc.). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound, etc.) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device, etc.) comprising a portion of the electronics 132 and the user interface 133 (e.g., a touch screen) without any speakers or microphones.

### III. Example Communication Systems

FIG. 1I, shows an example communication system 150 that includes example switching circuitry 160 and/or communication circuitry 165 configurations. The communication system 150 may be implemented in, for example, any of a variety of network devices including the playback devices 110. For example, the communication system may be used to communicate with other playback devices or components of a home theater system. Such communication may include instructions, control signals, or messages of any type.

Referring to FIG. 1I, in some embodiments, the communication circuitry 165 is coupled to a common port of the switching circuitry 160 and comprises a front-end circuit 170, a filter 187, a transceiver 190, and a filter 185. Optionally, in some embodiments, the filter 187 and/or the filter 185 may be included in the front-end circuit 170. Further, in some embodiments, the transceiver 190 may be coupled to the one or more processors 112a. The transceiver 190 may be configured for operation in multiple modes (e.g., a UWB mode, a 2.4 GHz WI-FI operation mode, a 5.0 GHz WI-FI operation mode, a 6.0 GHz WI-FI operation mode, and/or a BLUETOOTH operation mode).

In some embodiments, the switching circuitry 160 may be configured to selectively couple one of antennas 155a and 155b to the communication circuitry 165 based on a received control signal. The switching circuitry 160 may be implemented using, for example, one or more switches such as a single-pole, double throw switch (SP2T) switch. In some examples, the control signal may be generated by, for example, the transceiver 190 (e.g., provided via a second control port (CTRL2)). In these examples, the transceiver 190 may comprise one or more network processors that execute instructions stored in a memory (e.g., a memory within the transceiver 190 such as an internal read-only memory (ROM) or an internal read-write memory) that causes the transceiver 190 to perform various operations. An antenna switching program (e.g., that controls the switching circuitry 160 in accordance with the methods described herein) may be stored in the memory and executed by the one or more network processors to cause the transceiver 190 to generate and provide control signals to the switching circuitry 160. In other examples, the control signal for the switching circuitry 160 may be generated by the processor 112a instead of the transceiver 190.

In some embodiments, the front-end circuit 170 may further include a diplexer 175 comprising (i) a first port coupled to a SP2T switch 177, (ii) a second port coupled to a single pole, triple throw (SP3T) switch 178, and (iii) a third port coupled to the switching circuitry 160. The diplexer 175 is configured to separate multiple channels, for example, using one or more filters. More specifically, the diplexer 175 receives a wide-band input from one or more of the antennas 155a and 155b (e.g., via the switching circuitry 160) and provides multiple narrowband outputs. For example, the diplexer 175 may provide a first narrow-band output for a 5 GHz frequency band at the first port to SP2T switch 177 and provide a second narrow-band output for a 2.4 GHz frequency band at the second port to SP3T switch 178.

In some embodiments, SP2T switch 177 comprises a first port coupled to a low noise amplifier (LNA) 180a, a second port coupled to a first transmit port (TX1) of the transceiver 190 (e.g., a 5.0 GHz WI-FI transmit port), and a common port coupled to the diplexer 175. The SP2T switch 177 is configured to selectively couple the common port of the SP2T switch 177 to either the first port or the second port of the SP2T switch 177 based on a received control signal. The control signal may be provided by, for example, the transceiver 190 (e.g., via a first control port (CTRL1) of the transceiver 190).

In some embodiments, SP3T switch 178 comprises a first port coupled to LNA 180b, a second port coupled via BPF 185 to a second transmit port (TX2) of the transceiver 190 (e.g., a 2.4 GHz WI-FI transmit port), a third port coupled to a third transmit port (TX3) of the transceiver 190 (e.g., a BLUETOOTH transmit port), and a common port coupled to the diplexer 175. The SP3T switch 178 is configured to selectively couple the common port of the SP3T switch 178 to either the first port, the second port, or the third port of the SP3T switch 178 based on a received control signal. The control signal may be provided by, for example, the transceiver 190 (e.g., via the first control port (CTRL1) of the transceiver 190).

In some embodiments, each of the LNAs 180a and 180b are further coupled to a first receive port (RX1) (e.g., a 5.0 GHz WI-FI receive port) and a second receive port (RX2) (e.g., a 2.4 GHz WI-FI and/or BLUETOOTH receive port) via filter 187, respectively, of the transceiver 190. In operation, the LNAs 180a and 180b amplify the wireless signals detected by the antennas prior to being received by the transceiver 190 (which may contain additional amplifiers such as additional LNAs) to improve receive sensitivity of the communication system 150. A bypass switch may be coupled in parallel with each of the LNAs 180a and 180b that may be controlled by the transceiver 190 (e.g., via the first control port CTRL1 of the transceiver 190). In operation, the bypass-switch allows the transceiver 190 (or other control circuitry) to close the bypass-switch when the signal received at the transceiver 190 is above a threshold to avoid saturation of one or more amplifiers in the transceiver 190. Thus, the bypass-switch may be open when the signal received at the transceiver 190 has an amplitude below a threshold to improve receive sensitivity and closed when the signal received at the transceiver 190 has an amplitude above the threshold to avoid amplifier saturation.

The filter 187 is desirable in some embodiments to filter out external noise from the environment. In a standard operating environment, there may be a lot of noise near and in the 2.4 GHz band including, for example, noise from cordless home phones, cell phones, etc. In operation, the filter 187 is configured to remove such wireless signal interference in the operating environment. The filter 187 may be designed as a bandpass (BPF) filter, a low-pass filter, and/or a high-pass filter.

The filter 185 may be desirable in some embodiments to reduce out-of-band energy in the output from the transceiver 190 (e.g., from the second transmit port TX2). For example, the output of the transceiver 190 may comprise some energy that is out-of-band when outputting a wireless signal in a channel that is on the edge of the band (e.g., channel 1 or channel 11 in a 2.4 GHz Wi-Fi band). The filter 185 may be designed as a BPF filter, a low-pass filter, and/or a high-pass filter. The filter 185 may, in some implementations, be implemented as a controllable filter (e.g., a controllable BPF). For example, the filter 185 may comprise a BPF and one or more switches that either allow the BPF to be incorporated into the signal path between the transceiver 190 and the SP3T switch 178 or bypassed. In this example, the transceiver 190 may provide a control signal (not shown) to the controllable filter to either have the BPF be included in the signal path or bypassed.

The filters 185 and 187 may be constructed in any of a variety of ways. For instance, the filters 185 and 187 may be constructed using one or more of: a surface acoustic wave (SAW) filter, a crystal filter (e.g., quartz crystal filters), and/or a bulk acoustic wave (BAW) filter. Further, the filter 185 need not be constructed in the same way as the filter 187. For instance, the filter 187 may be implemented as a SAW and the filter 185 may be implemented as another type of filter.

It should be appreciated that the communication system 150 shown in FIG. 1I may be modified in any of a variety of ways without departing from the scope of the present disclosure. For example, the number of one or more components (e.g., antennas, filters, front-end circuits, etc.) may be modified based on the particular implementation. For instance, as shown in FIG. 1I, the number of antennas may be reduced to 1 (shown as antenna 155a) and, as a result of reducing the number of antennas, the switching circuitry 160 may be removed altogether.

Further, in some embodiments, the wireless transceiver 190 may be implemented as a Multi-Input and Multi-Output (MIMO) transceiver (e.g., a 2×2 MIMO transceiver, 3×3 MIMO transceiver, 4×4 MIMO transceiver, etc.) instead of a Single-Input-Single-Output (SISO) transceiver as shown in FIG. 1I. In such an implementation, the front-end circuit 170 may be duplicated for each additional concurrently supported transmit and/or receive signal chain supported by the MIMO transceiver. For instance, the communication circuitry 165 may comprise three front-end circuits 170 for a 3×3 MIMO wireless transceiver (one front-end circuit 170 for each supported transmit and/or receive signal chain). Further, in such MIMO transceiver implementations, the switching circuitry 160 may be removed in some cases. For instance, the switching circuitry 160 may be removed in cases where the number of antennas is equal to the number of supported concurrent transmit and/or receive signal chains (e.g., the switching circuitry 160 may be removed when using two antennas with a 2×2 MIMO transceiver). In other cases, the switching circuitry 160 may still be employed. For example, the communication system 150 may comprise six antennas and a 2×2 MIMO transceiver. In this example, the communication system 150 may still employ switching circuitry 160 to down select from the six antennas to the two antennas that may be coupled to the 2×2 MIMO transceiver at a given time.

### IV. Example Systems and Devices

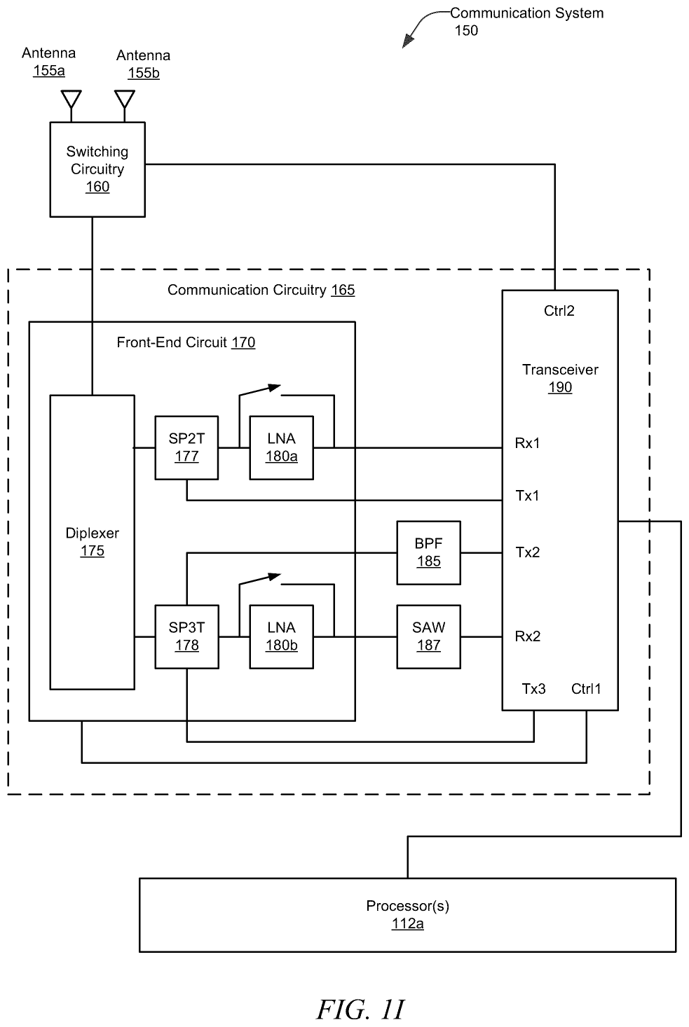

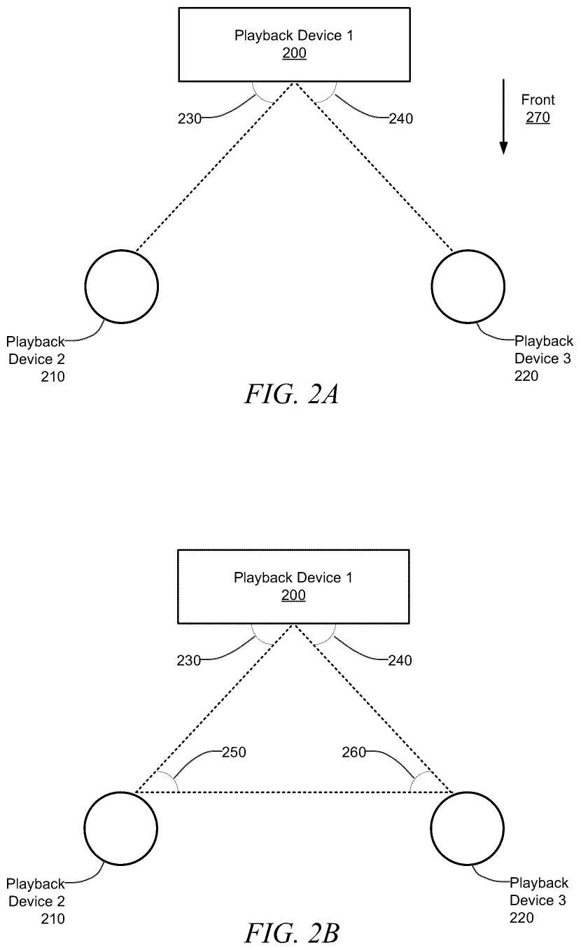

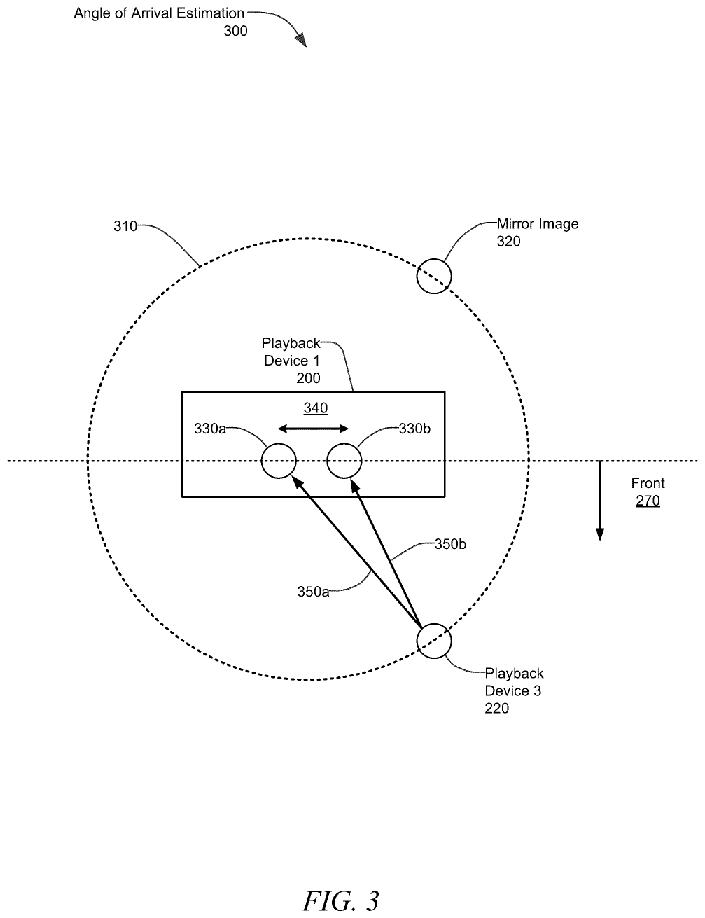

As discussed above, playback devices in a media playback system may comprise one or more wireless radios (e.g., an RF radio such as a UWB radio) that may be employed to determine a location of those playback devices relative to each other (e.g., a location of a first playback device relative to a second playback device). For instance, FIG. 2A illustrates an example configuration that includes three playback devices 200, 210, 220 positioned within a space (e.g., a room in a house, a product demonstration area within a store, etc.). The first playback device 200 may be a home theater or a soundbar, for example, while second and third playback devices 210 and 220 may be left and right satellite stereo speaker pairs, although other configurations are possible. For example, the first playback device 200 may be any playback device configured to receive multi-channel audio content. The first playback device 200 is shown to be front facing 270. In this example, the first playback device 200 applies AOA estimation techniques to RF signals that are transmitted from the second and third playback devices 210 and 220. The AOA estimation techniques are used to determine angles 230 and 240 to the second and third playback devices, relative to the first playback device. In some embodiments, the complement of the angles 230 and 240 may be determined as an equivalent alternative. These angles 230, 240 may then be employed for any suitable purpose including, for example, determining which of playback devices 210 and 220 are the left speaker and the right speaker, allocating audio channels to those devices, performing acoustic tuning (e.g., frequency equalization, volume adjustments, etc.), providing synchronization between those devices, and/or facilitating setup of the audio system.

In some embodiments, the transmitted RF signals are UWB signals (e.g., signals characterized by a center frequency in the range of 3.1-10.6 GHz and a bandwidth greater than the lesser of 500 MHz or 20% of the center frequency).

FIG. 2B illustrates another example configuration that includes three playback devices 200, 210, 220. In this example, all three playback devices are configured to employ AOA estimation techniques to RF signals that are transmitted between the devices such that additional angles 250 and 260 can be determined, either as an alternative to angles 230, 240 or as a supplement to those angles. In some embodiments, having additional angle estimates may improve estimation accuracy, for example by providing a discrepancy check or allowing for averaging to reduce error.

FIG. 3 illustrates an example of AOA estimation 300 in accordance with aspects of the disclosed technology. The first playback device 200 is shown to include two antennas 330a and 330b separated by a distance 340. These antennas each receive a signal, 350a, 350b respectively, that is transmitted from the third playback device 220. The relative phase difference between the two received signals 350a and 350b is measured and used to estimate the AOA 240 in a 2D plane. While the AOA 240 indicates the direction from the first playback device to the third playback device, there is an inherent ambiguity that results from the AOA estimation process in that the third playback device could be located at either the true position indicated in FIG. 3 or at the mirror image location 320. This ambiguity can be resolved in any of a variety of ways. For instance, the second and third playback devices may be assumed to be located in front 270 of the first playback device (instead of behind it). In another example, the two antennas 300a and 330b may be constructed and/or positioned in the playback device 200 so as to have a null area that overlaps with the mirror image 320 (e.g., directional antennas positioned to face the front 270). In yet another example, in some embodiments, the ambiguity could also be resolved through the use of additional AOA estimates 250, 260 if the second and third playback devices are configured with that capability.

The distance 340 between antennas 330a and 330b is selected to be a fraction of the wavelength of the RF signal, for example less than one half of the wavelength corresponding to the center frequency of the UWB signal. The choice of distance involves a tradeoff. Larger distances provide improved noise immunity, but as the distance exceeds half of the wavelength, the angular range over which valid AOA measurements can be obtained decreases.

In some embodiments, a third antenna may be employed to obtain AOA measurements in 3 dimensions, as described in greater detail below.

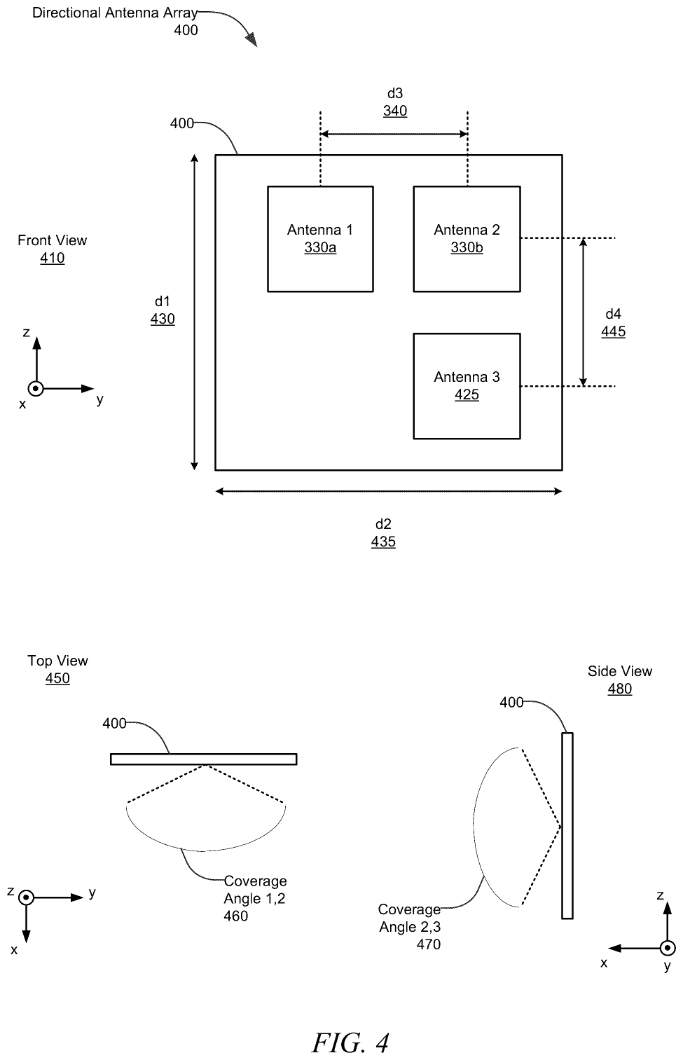

FIG. 4 illustrates a directional antenna array 400 configured in accordance with aspects of the disclosed technology. The directional antenna array 400 is shown to comprise first and second antenna elements 330a and 330b, which are shown in a front view 410 (with x, y, z axes as indicated). In some embodiments, a third antenna element 425 may also be included in the array to provide 3-dimensional AOA estimation. For example, measured phase difference between the signal received at the first antenna element 330a and the signal received at the second antenna element 330b can determine an AOA in the x/y plane, while measured phase difference between the signal received at the second antenna element 330b and the signal received at the third antenna element 425 can determine an AOA in the x/z plane. Combining these 2-dimensional AOAs provides a 3-dimensional AOA in the x/y/z space.

FIG. 4 also illustrates a top view 450 of the array 400 which shows an example directional coverage angle 460 of the first and second antenna elements. Side view 480 shows an example directional coverage angle 470 of the second and third antenna elements.

Antenna elements 330a and 330b are shown to be separated by distance d3 340. Antenna elements 330b and 425 are shown to be separated by distance d4 445. In some embodiments d4 may be equal to d3, although this is not required. The overall dimensions of directional antenna array 400 are shown as d1 430 by d2 435 and may correspond to the substrate or structure upon which the antenna elements 330a, 330b, and 425, are mounted.

In some embodiments, the antenna elements 330a, 330b, and 425 may be patch antennas. In some embodiments, the antenna elements may be linearly polarized (e.g., linearly polarized single-band or dual-band antennas) for applications where the antennas of all playback devices will be configured in a single common orientation (e.g., such that the linear polarization of a transmit antenna matches the linear polarization of a receive antenna). For applications where playback devices may be oriented in arbitrary positions (e.g., vertical or horizontal orientation), the antenna elements may be circularly polarized patch antennas. In some embodiments, the antenna elements 330a, 330b, and 425 may be of the same design, construction, and polarization, whether patch antennas or other types antennas.

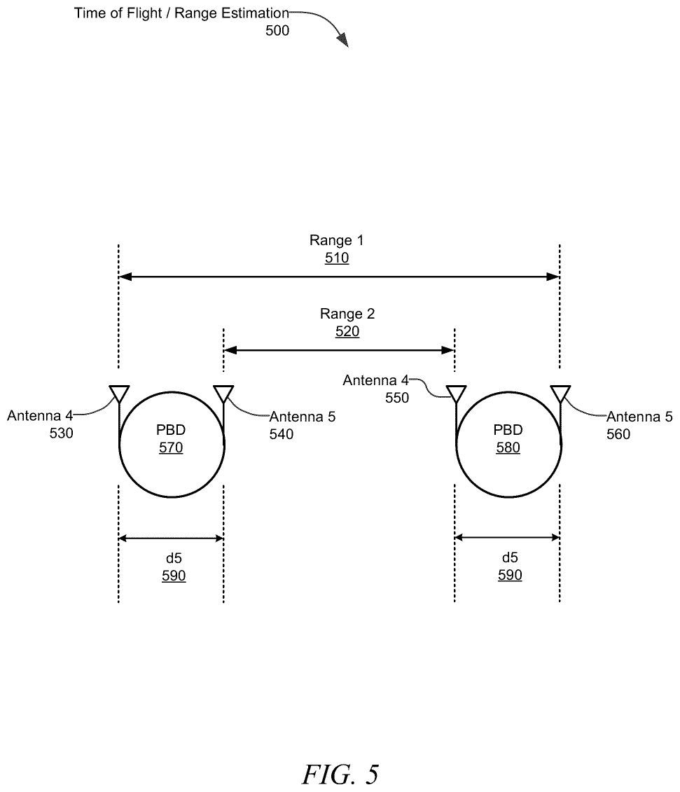

Having described how relative locations of playback devices may be determined using AOA measurements, it should be appreciated that the relative locations of playback devices may be determined using other types of measurements. In some embodiments, playback devices in a media playback system may (additionally or alternatively to AOA measurements) employ time-of-flight (ToF) measurements (e.g., one way ranging, two way ranging, etc.) to determine their location relative to each other. For instance, FIG. 5 illustrates an example of ToF estimation 500 in accordance with aspects of the disclosed technology. ToF estimation of a signal transmitted between two playback devices is equivalent to range estimation given that the signal speed is known (e.g., the speed of light, c). A first playback device 570 is shown to include two antennas 530 and 540 and a second playback device 580 is shown to include two antennas 550 and 560. Playback devices 570 and 580 may be any of the playback devices 200, 210, and 220 shown in FIGS. 2A and 2B and previously described. The antennas 530, 540, 550, and 560 are referred to as antennas 4 and 5 to indicate that they may be included as additional or alternative antennas to previously described antennas 1, 2, and 3. Antennas 4 and 5 are separated by a distance d5 590.

A first range 510 is calculated between the outer antennas (antenna 4, 530 of the first playback device 570 and antenna 5, 560 of the second playback device 580), based upon a ToF measurement of signal transmission between the playback devices. A second range 520 is calculated between the inner antennas (antenna 5, 540 of the first playback device 570 and antenna 4, 550 of the second playback device 580), based upon the signal ToF measurement. If playback device 570 is located to the left of playback device 580, as shown in FIG. 5, then range 1 will be greater than range 2, and the difference between the ranges is expected to be approximately twice the antenna separation d5 590. Likewise, if playback device 570 is located to the right of playback device 580, then range 2 will be greater than range 1, by approximately twice the antenna separation d5 590. In this manner, ToF measurements, and in particular a time difference of arrival between two antennas on a playback device, can be used to determine the relative position of playback devices 570 and 580. Determination of relative position can then be used, for example, to discriminate between left and right speakers in a stereo pair, allocate audio channels to those devices, perform acoustic tuning (e.g., frequency equalization, volume adjustments, etc.), provide synchronization between those devices, and/or facilitate setup of the audio system.

In some embodiments, additional ranges can be calculated between antennas 530 and 550 and between antennas 540 and 560. These two additional ranges are expected to be approximately equal and thus could be used to detect possible measurement errors if they differ by more than a selected threshold amount.

In some embodiments, the signal transmission between playback devices is a UWB signal, as described previously. In some embodiments, antennas 4 and 5 are monopole antennas or other suitable antennas having relatively omnidirectional characteristics. In some embodiments, antennas 4 and 5 are etched endfire array antennas. In some embodiments, the antenna spacing d5 590 may be in the range of 35 to 45 mm. In some other embodiments, the antenna spacing d5 590 may be in the range of 90 to 110 mm.

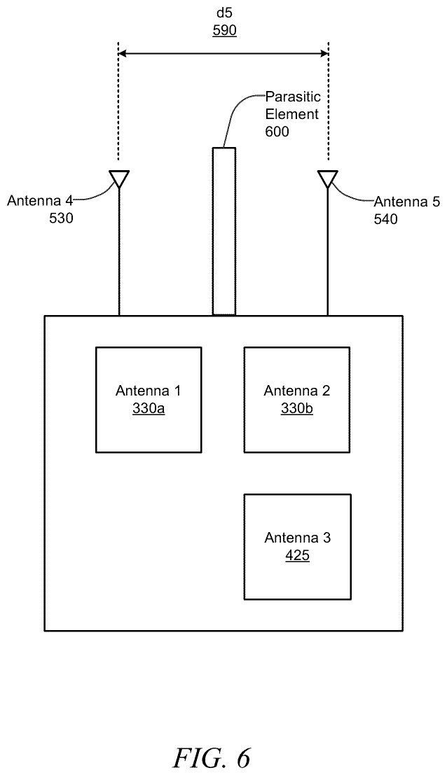

FIG. 6 illustrates an example playback device that includes five antennas configured in accordance with aspects of the disclosed technology. Antennas 1-3: 330a, 330b, and 425, which may be directional patch antennas, are employed to perform AOA estimation as previously described. Antennas 4 and 5:530 and 540, which may be relatively omnidirectional monopole antennas, are employed to perform ToF/Range estimation as previously described.

In this example, a parasitic element 600 is disposed between antennas 4 and 5 to induce a difference in received signal strength (e.g., power) between the left and right antennas. For example, a signal arriving from the left side will be received by antenna 5 in an attenuated state due to the parasitic element 600, while the signal received by antenna 4 will be relatively unaffected. In some embodiments, the received power difference between antennas may be on the order of 7 dB. This difference in signal strength may be employed as an additional indicator of the relative direction of the transmitting playback device relative to the receiving playback device. This additional indicator can replace or supplement the information provided by the ToF/Range estimation and may allow for closer spacing of antennas 4 and 5 (e.g., substantially less than 40 mm) which may be useful in smaller form factor playback devices.

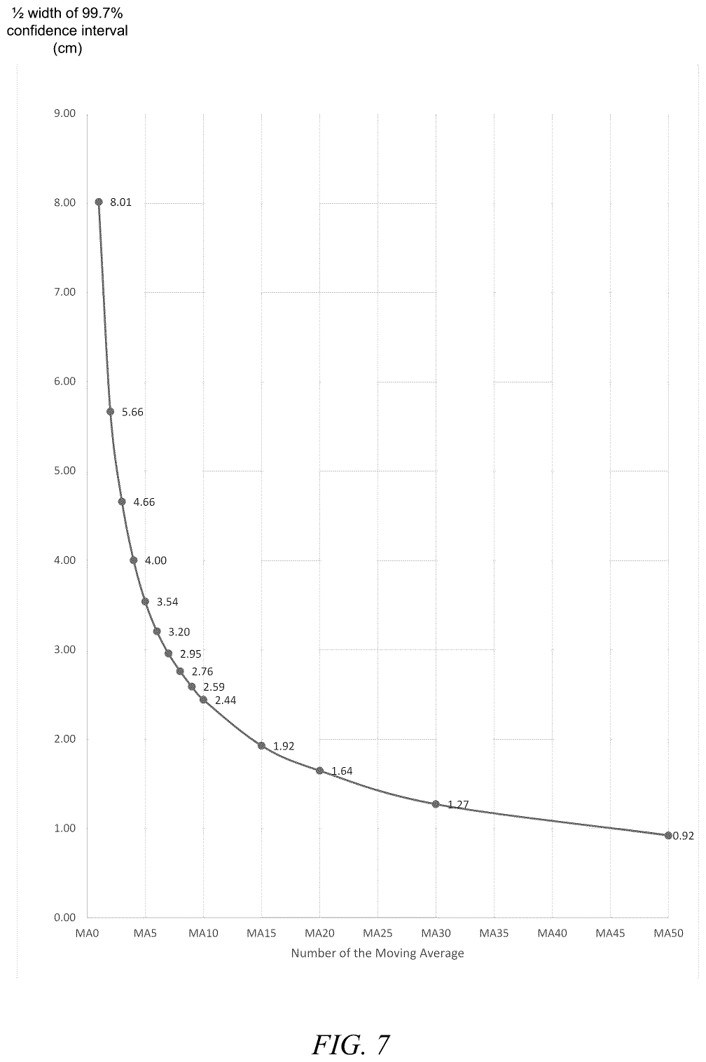

FIG. 7 is a plot of the range estimate confidence intervals (in cm) versus the number of moving averages (MAs) that are performed in accordance with aspects of the disclosed technology. Because ToF measurements are subject to noise, error is induced in the resulting range estimates. This error imposes a limit on how closely the antennas can be spaced. One way to reduce the error is to capture multiple range measurements and average (or otherwise filter) those values to mitigate the noise. This is illustrated in FIG. 7 which shows range estimate confidence intervals within three standard deviations (which is the half width of the 99.7% confidence interval) as a function of the number of moving averages (MAs) that are performed. The plot can be generated by capturing a set of range measurements (in centimeters) at each of a set of physical distances and computing the standard deviation for those range measurements for each physical distance in the set of physical distances. The standard deviations for each of the physical distances are averaged and multiplied by 3 to get the 3x averaged standard deviation value.

The plot shows a reduction in the confidence interval from approximately 8 cm for a single measurement down to approximately 1 cm for an MA length of 50. The plot follows an inverse square root law, for example, confidence interval falls as 1/(MA). The plot also shows that there is a knee in the curve, at an MA of approximately 10 to 15. Thus, in some embodiments, the MA length may be chosen to be greater than 10 or 15. In some embodiments, measurements may be performed until the average of those measurements yields a difference in range that exceeds a minimum threshold. The minimum threshold may be based on the antenna spacing. Generally, more measurements and averaging will be employed for playback devices having smaller spacing between the antennas given that the range difference is smaller relative to the measurement noise.

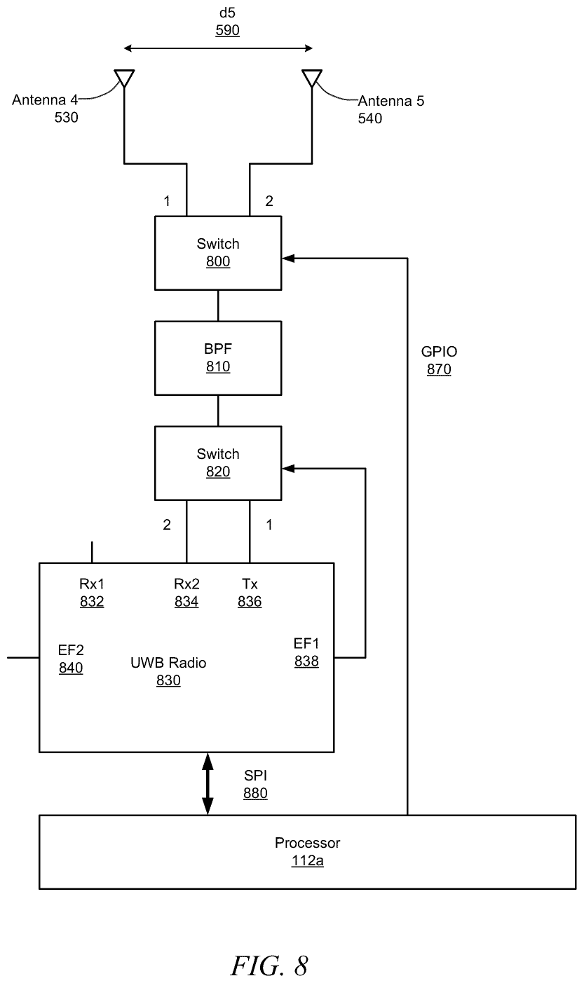

FIG. 8 illustrates a playback device configured to perform ToF/range estimation in accordance with aspects of the disclosed technology. Referring to FIG. 8, the playback device is shown to include fourth antenna 530, fifth antenna 540, first switch 800, second switch 820, BPF 810, UWB radio 830, and processor 112a. In some embodiments, the processor 112a is configured to communicate with the UWB radio 830 over a serial peripheral interface (SPI) bus. In some embodiments, the processor 112a is configured to control switch 800 over a general purpose I/O (GPIO) bus 870.

In some embodiments, UWB radio 830 is configured to selectively transmit or receive UWB signals, through either of antennas 530 or 540, under the control of processor 112a. In transmit mode, switch 820 is controlled, by a signal issued through port EF1 838, to couple transmit port 836 to the BPF 810. The filtered signal will be coupled to either antenna 530 or antenna 540 based on the setting of switch 800 which is controlled by a signal on GPIO bus 870 issued by processor 112a. Thus, an RF path can be established between the transmit port 836 and one of the antennas 530 or 540. The UWB radio 830 is further configured to accept a signal (e.g., a baseband signal) from the processor 112a (e.g., over the SPI bus 880), and generate an RF UWB signal for transmission through either antenna 530 or 540.

In receive mode, switch 820 is controlled, by a signal issued through port EF1 838, to couple receive port 834 to the BPF 810. Additionally, either antenna 530 or antenna 540 is coupled to the BPF 810 based on the setting of switch 800 which is controlled by a signal on GPIO bus 870 issued by processor 112a. Thus, an RF path is established between the receive port 834 and one of the antennas 530 or 540. The UWB radio 830 is also configured to convert received RF UWB signals to baseband and provide the baseband signals to the processor 112a (e.g., over the SPI bus 880). The UWB radio 830 is further configured to provide ToF and/or time difference of arrival (TDOA) measurements of the signals, received through the antennas, to the processor.

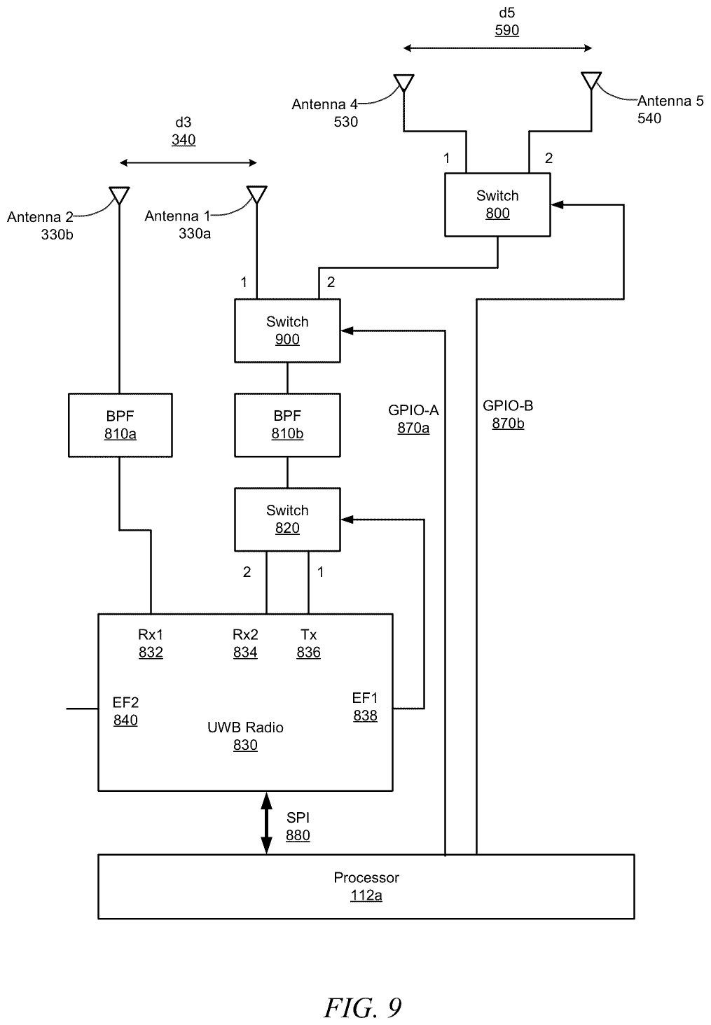

FIG. 9 illustrates a playback device configured to perform either or both ToF/range estimation and 2-dimensional AOA estimation in accordance with aspects of the disclosed technology. Referring to FIG. 9, the playback device is shown to include first antenna 330a, second antenna 330b, fourth antenna 530, fifth antenna 540, first switch 800, second switch 820, third switch 900, BPFs 810a and 810b, UWB radio 830, and processor 112a. In some embodiments, the processor 112a is configured to communicate with the UWB radio 830 over a serial peripheral interface (SPI) bus 880. In some embodiments, the processor 112a is configured to control switch 900 over a general purpose I/O (GPIO-A) bus 870a and to control switch 800 over a general purpose I/O (GPIO-B) bus 870b.

In some embodiments, UWB radio 830 is configured to selectively transmit or receive UWB signals, through any of antennas 330a, 530, and 540, and to receive UWB signals through antenna 330b. Switch 800 allows for the selection of either antenna 530 or antenna 540, as controlled by GPIO-B signal 870b issued by processor 112a. Switch 900 allows for the selection of either the antenna group 530 and 540 or of antenna 330a, as controlled by GPIO-A signal 870a issued by processor 112a. The antenna group 530 and 540 may be used for ToF and/or TDOA measurements, while antenna 330a may be used in combination with antenna 330b for AOA measurement. Switch 820 determines whether the selected antenna (from the group of 330a, 530, and 540) is used for transmit mode (through transmit port 836) or receive mode (through receive port 834), based on a signal issued through port EF1 838. BPF 810b is configured to provide any desired filtering of the signals that pass between switch 820 and switch 900. Thus, an RF path can be established between either the receive port 834 or the transmit port 836 and any one of the antennas 330a, 530, or 540, so that any of these 3 antennas can be used for either signal reception or transmission at different times.

Additionally, antenna 330b is coupled to receive port 832 of the UWB radio through BPF 810a, which allows for simultaneous reception of signals through antennas 330a and 330b, for AOA estimation, given an appropriate selection of switching states of switches 820 and 900 (e.g., switch 900 set to state 1 and switch 820 set to state 2).

The UWB radio 830 is configured to provide ToF and/or TDOA measurements of the signals, received through antennas 530 and 540, to the processor. The UWB radio 830 is further configured to provide AOA measurements of the signals, received through antennas 330b and 330a, to the processor 112a.

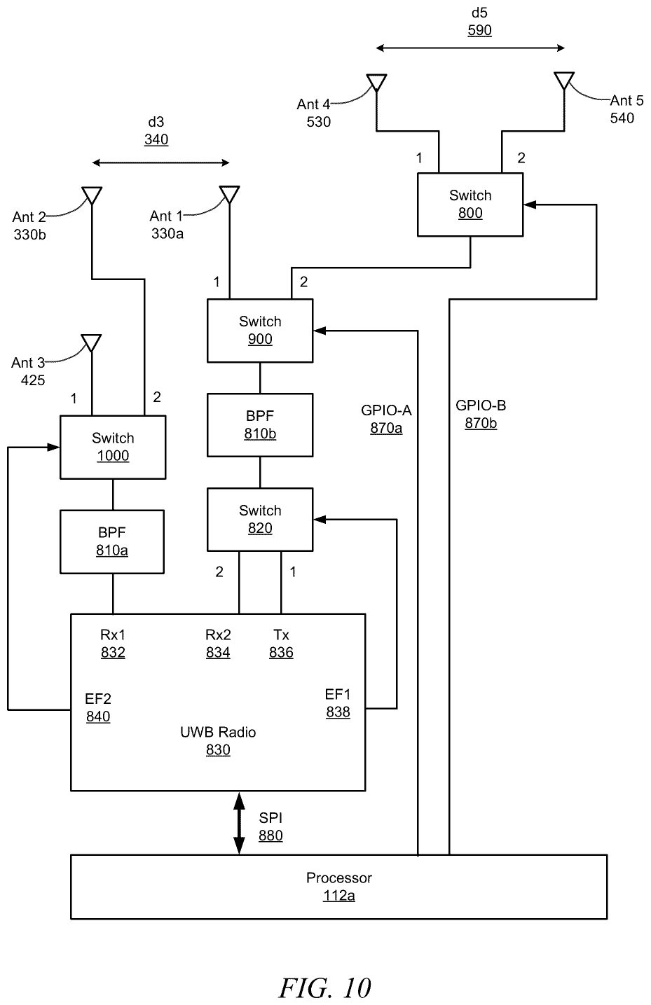

FIG. 10 illustrates a playback device configured to perform both ToF/range estimation and 3-dimensional AOA estimation in accordance with aspects of the disclosed technology. Referring to FIG. 10, the playback device is shown to include first antenna 330a, second antenna 330b, third antenna 425, fourth antenna 530, fifth antenna 540, first switch 800, second switch 820, third switch 900, fourth switch 1000, BPFs 810a and 810b, UWB radio 830, and processor 112a. In some embodiments, the processor 112a is configured to communicate with the UWB radio 830 over a serial peripheral interface (SPI) bus 880. In some embodiments, the processor 112a is configured to control switch 900 over a general purpose I/O (GPIO-A) bus 870a and to control switch 800 over a general purpose I/O (GPIO-B) bus 870b.

In some embodiments, UWB radio 830 is configured to selectively transmit or receive UWB signals, through any of antennas 330a, 530, and 540, and to receive UWB signals through either of antennas 330b and 425. Switch 800 allows for the selection of either antenna 530 or antenna 540, as controlled by GPIO-B signal 870b issued by processor 112a. Switch 900 allows for the selection of either the antenna group 530, 540 or of antenna 330a, as controlled by GPIO-A signal 870a issued by processor 112a. The antenna group 530 and 540 may be used for ToF and/or TDOA measurements, while antenna 330a may be used in combination with antenna 330b for AOA measurement. Switch 820 determines whether the selected antenna (from the group of 330a, 530, and 540) is used for transmit mode (through transmit port 836) or receive mode (through receive port 834), based on a signal issued through port EF1 838. BPF 810b is configured to provide any desired filtering of the signals that pass between switch 820 and switch 900. Thus, an RF path can be established between either the receive port 834 or the transmit port 836 and any one of the antennas 330a, 530, or 540, so that any of these 3 antennas can be used for either signal reception or transmission at different times.

Additionally, antennas 330b and 425 are coupled to receive port 832 of the UWB radio through switch 1000 and BPF 810a, which allows for simultaneous reception of signals through antenna 330a and either of antennas 330b or 425, for 3-dimensional AOA estimation, given an appropriate selection of switching states of switches 820, 900, and 1000 (e.g., switch 900 set to state 1, switch 820 set to state 2, and switch 1000 set to either state 1 for antenna 425 or state 2 for antenna 330b). Switch 1000 is controlled by a signal issued through port EF2 840.

The UWB radio 830 is configured to provide ToF and/or TDOA measurements of the signals, received through antennas 530 and 540, to the processor. The UWB radio 830 is further configured to provide 3-dimensional AOA measurements of the signals, received through antenna pairs (330a, 330b) and (330a, 425), to the processor.

In some embodiments, the playback devices illustrated in FIGS. 8-10 may include additional radios (not shown), including additional UWB radios and/or radios configured for Bluetooth and/or Wi-Fi transmission and reception. It should be noted that the various switching configurations described above are examples and that numerous other configurations are possible.

In some embodiments, the UWB radio or one of the additional radios may be used to transmit instructions from one playback device to other playback devices. The instructions may include instructions to set playback configurations, for example to select channels from multi-channel audio content or for any other suitable purpose.

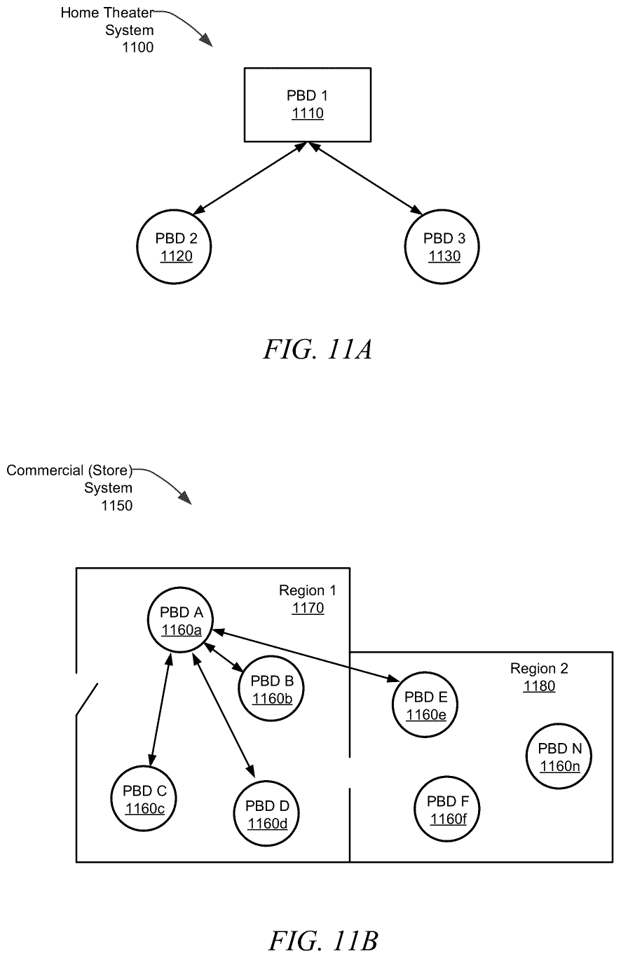

As discussed above, playback devices in a media playback system may comprise one or more wireless radios (e.g., an RF radio such as a UWB radio) that may be employed to determine a location of those playback devices relative to each other (e.g., a location of a first playback device relative to a second playback device). For instance, FIG. 11A illustrates an example configuration 1100 that includes three playback devices 1110, 1120, 1130 positioned within a space (e.g., as a home theater system in a room of a house or a product demonstration area within a store, etc.). The first playback device 1110 may be a home theater or a soundbar, for example, while second and third playback devices 1120 and 1130 may be left and right satellite stereo speaker pairs, although other configurations are possible. For example, the first playback device 1110 may be any playback device configured to receive multi-channel audio content. In this example, the first playback device 1110 employs ToF based range estimation techniques, based on RF signals that are transmitted between the devices, to determine the relative locations of second and third playback devices 1120, 1130, using trilateration. The relative locations may then be used, for example, to determine which of playback devices 1120 and 1130 are the left speaker and the right speaker, allocating audio channels to those devices, performing acoustic tuning (e.g., frequency equalization, volume adjustments, etc.), providing synchronization between those devices, and/or facilitating setup of the audio system.

FIG. 11B illustrates another example configuration 1150 that includes many playback devices 1160a, . . . 1160n (e.g., in a commercial application, for example a facility such as a store or shopping center). The playback devices may, in some instances, be recessed in ceiling or other locations that are relatively difficult to access. The playback devices 1160 may be distributed throughout different rooms or regions 1170, 1180 of the facility. Any of the playback devices, for example playback device A 1160a, may be configured to employ ToF based range estimation techniques, based on RF signals that are transmitted between the devices, to determine the relative locations of one or more of the other playback devices 1160b, . . . 1160n, using trilateration. The relative locations may then be used, for example, to allocate audio channels to those devices, perform acoustic tuning (e.g., frequency equalization, volume adjustments, etc.), provide synchronization between those devices, and/or facilitate setup of the audio system without requiring manual adjustment or physical access to the devices by a user or installer of the system.

In some embodiments, the playback devices may be configured to include Power-over-Ethernet (POE) interfaces to provide power for operation of the device through an Ethernet cable.

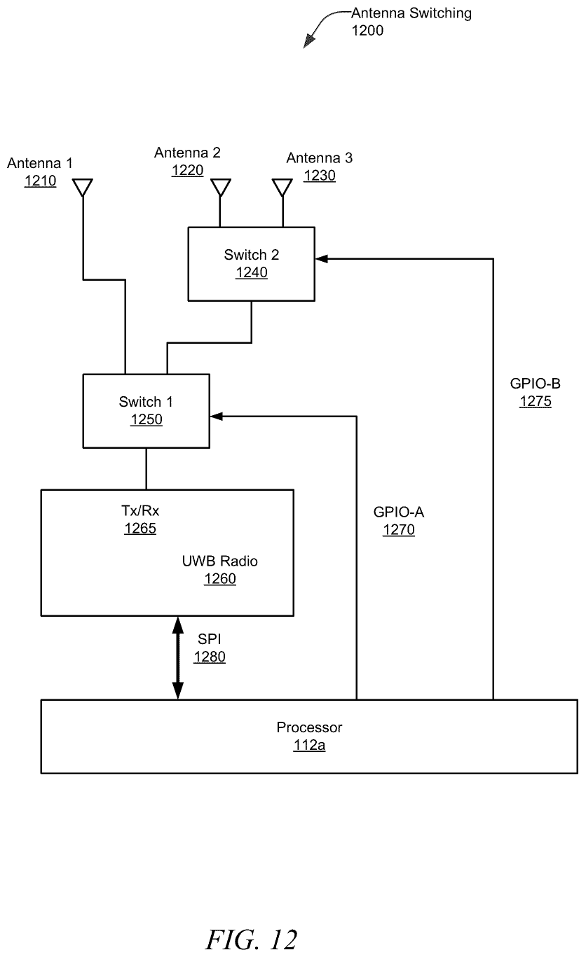

FIG. 12 illustrates antenna switching 1200 for a playback device configured to perform ToF/range estimation in accordance with aspects of the disclosed technology. Referring to FIG. 12, the playback device is shown to include a first antenna 1210, a second antenna 1220, an optional third antenna 1230, a first switch 1250, a second switch 1240, a UWB radio 1260, and processor 112a. In some embodiments, the processor 112a is configured to communicate with the UWB radio 1260 over a serial peripheral interface (SPI) bus 1280. In some embodiments, the processor 112a is configured to control switches 1240 and 1250 by issuing control signals to the switches over general purpose I/O (GPIO) busses GPIO-A 1270 and GPIO-B 1275.

In some embodiments, UWB radio 1260 is configured to selectively transmit or receive UWB signals, through any of antennas 1210, 1220, or 1230, under the control of processor 112a. In transmit mode, signals are routed from the transmit/receive port 1265 of the UWB radio 1260 to one of the antennas 1210, 1220, or 1230 based on control signals applied by the processor to switches 1250 and 1240. In receive mode, signals are routed from one of the antennas 1210, 1220, or 1230 to the transmit/receive port 1265 of the UWB radio 1260 based on control signals applied by the processor to switches 1250 and 1240. Thus, an RF path can be established between the transmit/receive port 1265 and one of the antennas 1210, 1220, or 1230.

The UWB radio 1260 is further configured to accept a signal (e.g., a baseband signal) from the processor (e.g., over the SPI bus 1280), in transmit mode, and generate an RF UWB signal for transmission through the selected antenna. In receive mode, the UWB radio 1260 is further configured to receive an RF UWB signal through the selected antenna and convert that signal to baseband to be provided to the processor (e.g., over the SPI bus 1280). The UWB radio 1260 is further configured to provide ToF measurements of the signals, received through the antennas, to the processor 112a.

The electrical path length between each of the antennas and the UWB radio can vary. For example, the paths from antennas 1220 and 1230 to the radio go through two switches while the path from antenna 1210 to the radio goes through only one switch. Additionally, the physical wiring, whether a cable or a trace on a circuit board, can vary due to routing constraints. These differences in electrical path length, if uncorrected, will introduce errors into the ToF measurements. Therefore, in some embodiments, a calibration process may be employed to measure the time delay through each of the antennas, for a signal received from a known location. The observed differences can then be used to correct for the varying electrical path lengths.

In some embodiments, the UWB radio 1260 may be used to transmit instructions from one playback device to other playback devices. The instructions may include instructions to set playback configurations, for example to select channels from multi-channel audio content or for any other suitable purpose.

The antennas may be constructed in any of a variety of ways and may (or may not) have the same construction. In some instances, the antennas may comprise one or more omnidirectional antennas (e.g., antennas with an omnidirectional radiation pattern). Additionally (or alternatively), the antennas may comprise one or more directional antennas (e.g., antennas with a directional radiation pattern). The particular construction of the antennas may vary based on the particular implementation. For instance, the antennas may comprise one or more monopole antennas (e.g., configured as omni directional antennas) and/or one or more patch antennas (e.g., configured as directional antennas). Accordingly, the antennas may be constructed in any of a variety of ways using any of a variety of structures.

In some embodiments, the RF signals are UWB signals (e.g., signals characterized by a center frequency in the range of 3.1-10.6 GHz and a bandwidth greater than the lesser of 500 MHZ or 20% of the center frequency).

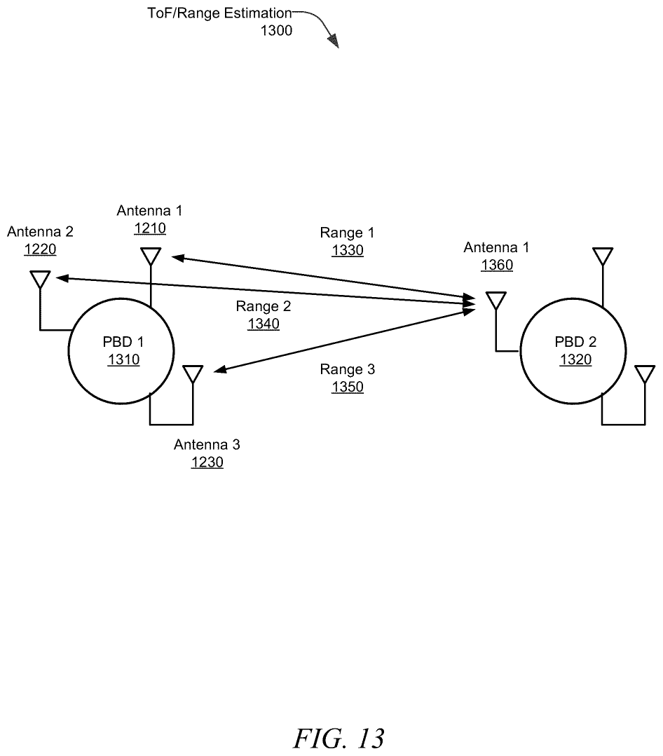

FIG. 13 illustrates an example of ToF/range estimation 1300 in accordance with aspects of the disclosed technology. In some embodiments, playback devices in a media playback system may employ ToF measurements (e.g., one way ranging, two way ranging, etc.) to determine their location relative to each other. ToF estimation of a signal transmitted between two playback devices is equivalent to range estimation given that the signal speed is known (e.g., range equals ToF divided by c, where c is the speed of light). A first playback device 1310 is shown to include three antennas 1210, 1220, and 1230. A second playback device 1320 is also shown to include three antennas, one of which, antenna 1 1360, is used in this ToF/ranging example. Playback devices 1310 and 1320 may be any of the playback devices 1110, 1120, 1130, or 1160 shown in FIGS. 11A and 11B and previously described.

A first range 1330 is calculated between antenna 1 1210 of the first playback device 1310 and antenna 1 1360 of the second playback device 1320, based upon a ToF measurement of signal transmission between the two playback devices. Likewise, a second range 1340 is calculated between antenna 2 1220 of the first playback device and antenna 1 1360 of the second playback device. Similarly, a third range 1350 is calculated between antenna 3 1230 of the first playback device and antenna 1 1360 of the second playback device.

In some embodiments, up to six additional ranges (e.g., for a total of 9 ranges) can be calculated between the three antennas of the first playback device and the other two antennas of the second playback device. In some embodiments, some of the playback devices may have only two antennas, in which case the number of potential calculated ranges would be reduced accordingly.

In some embodiments, the antennas may be positioned at locations on the playback devices that are selected to maximize the distance between the antennas. For example, in a circular shaped playback device, the antennas may be located at or near the outer perimeter of the device with approximately 120 degrees of angular separation between each antenna. Increasing the distance between antennas generally decreases errors in the trilateration based location estimate. In some embodiments, the antennas may also be disposed on the device in a configuration that avoids or reduces the number of conductive elements that may be located between the antennas, as such conductive elements can degrade the UWB signals (e.g., causing reflections, attenuation, etc.).

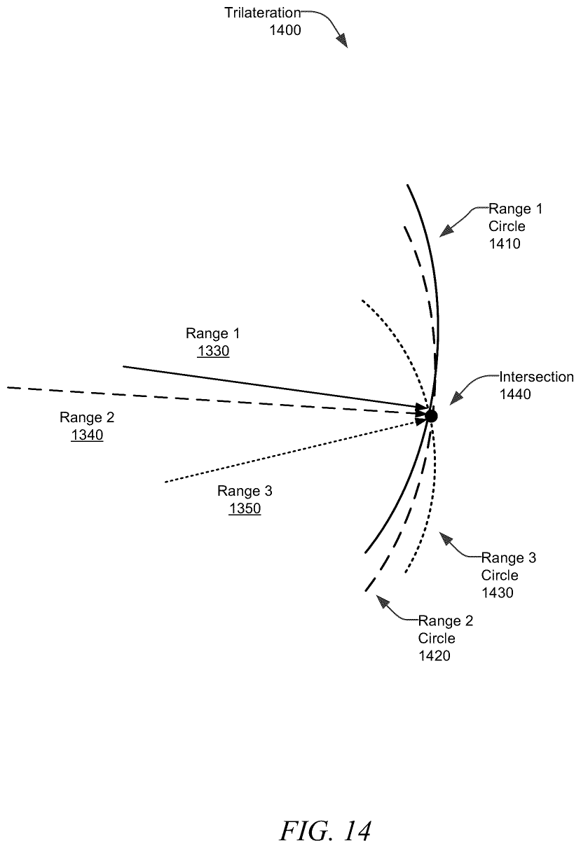

FIG. 14 illustrates an example of trilateration 1400 in accordance with aspects of the disclosed technology. Having determined two or more ranges between antennas of the first and second playback devices, as described above, trilateration may then be employed to estimate the location of the second playback device 1320 relative to the first playback device 1310.

Knowledge of the first range 1330 locates the second playback device 1320 at some point along a first range circle 1410. The second range 1340 further constrains the location of the second playback device to a point along a second range circle 1420 and thus provides a location estimate at the intersection point 1440 of those two circles, although there can be an ambiguity to this estimate as will be discussed below. The third range 1350 provides additional information to further constrain the location of the second playback device to a point along a third range circle 1430. Ideally, all three range circles would intersect at the same point 1440, but various sources of measurement error can result in two intersection points, which in some embodiments may be averaged (or otherwise combined) to obtain an improved location estimate. In some embodiments, additional ranges, beyond those three, can be obtained to provide additional intersection points that may be used to further improve the location estimate, through averaging or median filtering, or other suitable mathematical techniques.

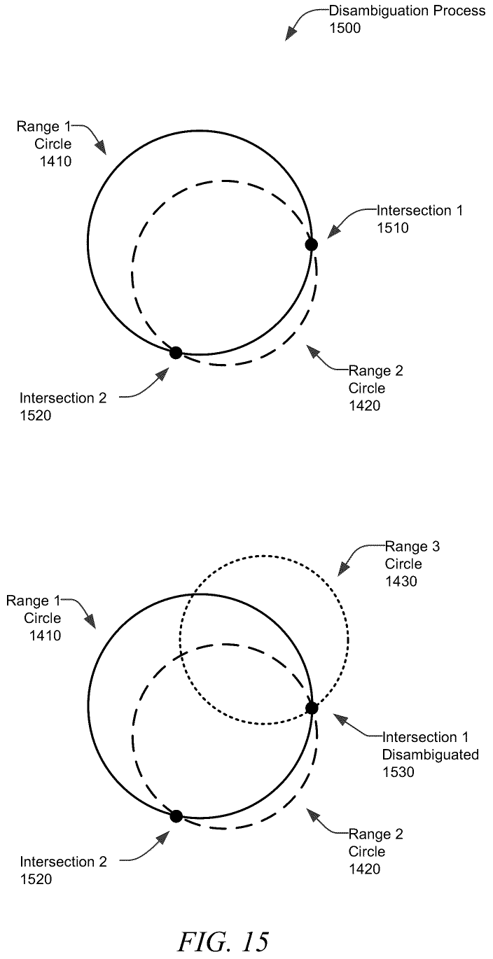

FIG. 15 illustrates an example of location disambiguation 1500 in accordance with aspects of the disclosed technology. As previously noted, some payback devices may have only two antennas that provide two range estimates, and this can result in a location ambiguity. For example, when the first range circle 1410 and the second range circle 1420 are drawn out to illustrate the full circles (the upper portion of FIG. 15), it can be seen that there are two intersection points 1510 and 1520. One of these intersection points corresponds to the location of the second playback device and the other intersection point is an artifact of the process. A third range can resolve or disambiguate the location. As shown in the lower portion of FIG. 15, the third range circle intersects with only one of the previous two intersection points providing a disambiguated location 1530.

In some embodiments, the first two ranges may be obtained from ToF measurements of signals received through two of the three antennas that are associated with the least error, while a third range is obtained from the antenna that is associated with the greatest error. The first two ranges may then be used to determine the two intersection points with relatively high accuracy, while the third range can be used merely for disambiguation between those two intersection points. The greater error associated with the third range may be too large to provide a refined estimate of the intersection point but may still be sufficiently low to provide acceptable disambiguation. In some embodiments, the antenna that is associated with the greatest error may be identified as the antenna that produces the largest ToF measurement, since that antenna is located furthest away from the source of the signal. A signal reaching that antenna will have had to travel through the playback device, which is likely to degrade the signal (e.g., through multipath reflections, attenuation, etc.), which can thus increase ToF measurement error.

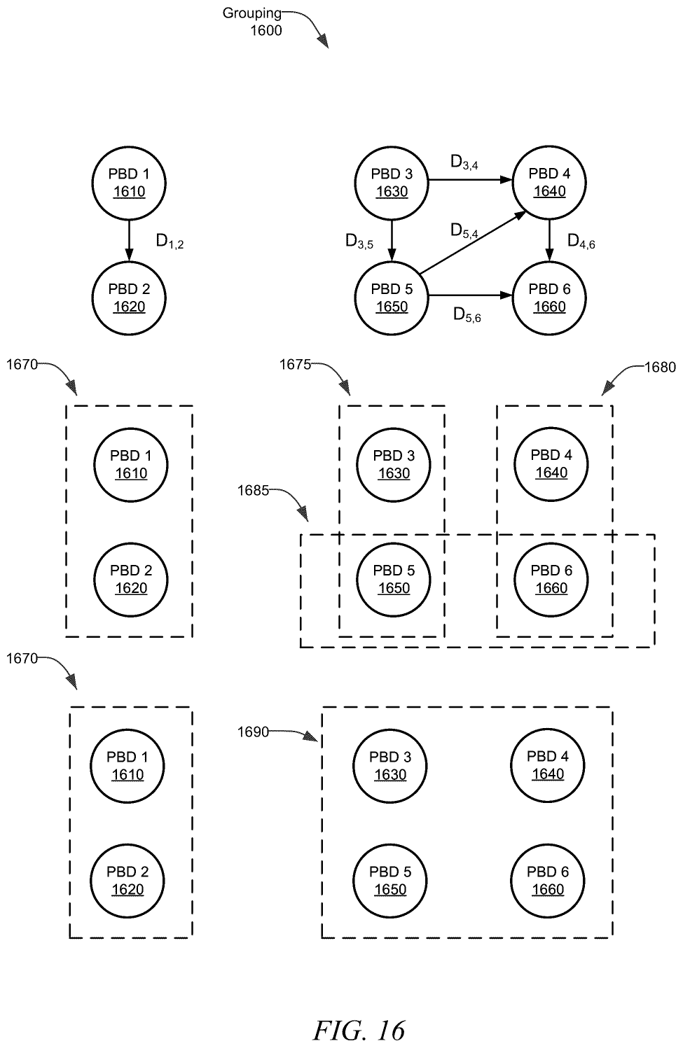

FIG. 16 illustrates an example of grouping of playback devices 1600 in accordance with aspects of the disclosed technology. In some embodiments, playback devices may be clustered together into different clusters, for example based on distance (e.g., range) between devices. These clusters of playback devices may be identified using ToF measurements such that each of the clusters of playback devices may be easily assigned to a specific group (e.g., for synchronous playback). As a result, a user may be able to deploy a large number of playback devices in a space and easily assign those playback devices to a handful of groups.

In some embodiments, the grouping process may include four steps. As shown in FIG. 16, a first step includes calculating distances between playback devices. For example, distance D1,2 is the distance between playback device 1 1610 and playback device 2 1620. Similarly, distance D3,4 is the distance between playback device 3 1630 and playback device 4 1640. Likewise, additional distances D3,5, D5,4, D5,6, D4,6, etc. may be calculated. The distances may be obtained as the ranges which are based on ToF measurements, as previously described.

After distances are obtained, a second step is to perform an initial clustering of devices based on a distance threshold. For example, if D1,2 is less than a threshold value then playback devices 1610 and 1620 may be combined into cluster 1670. Similarly, playback devices 1630 and 1650 may be joined into cluster 1675, playback devices 1640 and 1660 may be joined into cluster 1680, and playback devices 1650 and 1660 may be joined into cluster 1685.

As a third step, overlapping cluster may then be combined. In this example, since groups 1675, 1680, and 1685 overlap, playback devices 1630, 1640, 1650, and 1660 may then be combined into a single group 1690.

Alternatively, in some embodiments, only those playback devices that have a line-of-sight communication path between them would be clustered together. This would also result in clusters of devices that are likely in the same room or that are otherwise not obstructed by an object or wall.

As a fourth step, the clusters of playback devices may be mapped to specific groups for synchronous playback. For instance, the identified clusters of playback devices may be presented (e.g., to a user) via a display of a user device (e.g., a control device) and request input (e.g., from the user) as to which synchrony group each of the clusters should be assigned. For example, a small store may deploy 50 playback devices including 20 playback devices in a first department and 30 playback devices in a second department. In this example, two clusters may be identified including a first cluster with 20 playback devices and a second cluster with 30 playback devices. In turn, the user may be prompted to assign each of the clusters to a specific group for synchronous playback (e.g., a first group for the first department and a second group for the second department).

### V. Example Methods

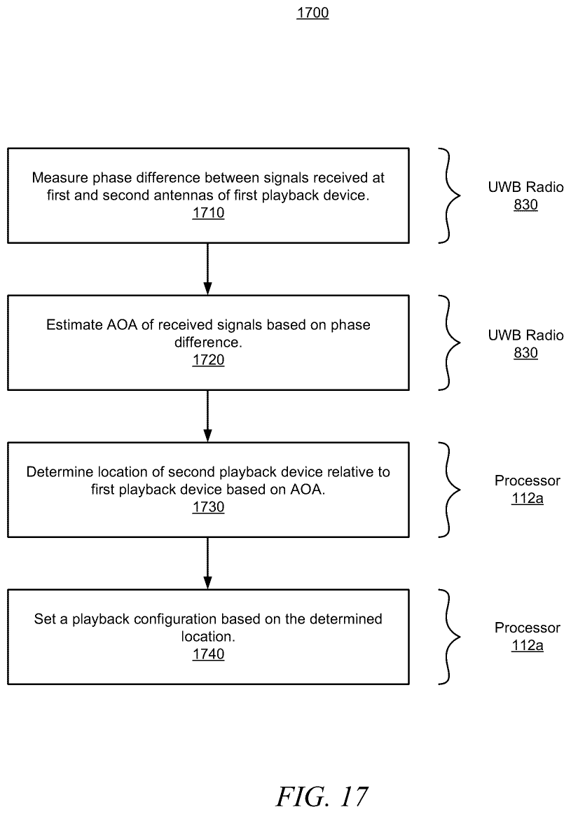

FIG. 17 shows an example embodiment of a method 1700 for a playback device employing a UWB radio to discriminate between other playback devices, based on AOA estimation techniques in accordance with aspects of the disclosed technology. As discussed above, the ability to discriminate between other playback devices, and to determine their relative locations, can be used for a number of purposes including, for example, to discriminate between left and right speakers in a stereo pair, allocate audio channels to those devices, perform acoustic tuning, provide synchronization between those devices, and/or facilitate setup of the audio system. For example, determining that a first playback device is located to the left of a second playback device enables the first playback device to be designated as a left speaker of a stereo pair and eliminates the need for a user to manually provide such information during system setup. Additionally, acoustic tuning, which may include the setting of equalization parameters, may depend on the locations of the playback devices. For example, the audio from a playback device which is located near a wall or in a corner of a room may benefit from specific equalization adjustments tailored to that location.

Method 1700 can be implemented by any of the playback devices (e.g., devices 200, 210, or 220) disclosed herein, individually or in combination with any of the computing systems (e.g., computing system(s) 106) and/or user devices (e.g., user devices 130) disclosed herein, or any other computing system(s) and/or user device(s) now known or later developed.

Method 1700 begins at block 1710, which includes measuring a phase difference between a signal received at a first antenna and a second antenna of a wireless radio of the playback device (e.g., a first playback device). The signal may be transmitted from another (e.g., a second) playback device. In some embodiments, the measurement may be performed by the UWB radio.

At block 1720, method 1700 further includes estimating an angle of arrival of the signal to the first playback device based on the measured phase difference. In some embodiments, the estimation may be performed by the UWB radio.

At block 1730, method 1700 further includes determining a location of the second playback device relative to the first playback device based on the angle of arrival. In some embodiments, additional sources of information may be employed to facilitate determination of the location of the playback device-such as information from other measurements (e.g., ToF measurements as described herein). In some embodiments, the determination may be performed by a processor of the first playback device.

At block 1740, method 1700 further includes, after a determination of the location of the second playback device relative to the first playback device, operating in a first playback configuration where the first playback device plays back one or more first channels of multi-channel audio content. The process may be repeated for signals received from additional playback devices to determine the relative locations of third, fourth, etc. playback devices. In some embodiments, the playback configuration may be set by a processor of the first playback device and may be based on the determined location of the second playback device relative to the first playback device.

In some embodiments, the method 1700 further includes, measuring a phase difference between a signal received at the second antenna and a third antenna of the wireless radio to estimate an additional AOA in a third dimension (e.g., a dimension orthogonal to the dimension of the first estimated AOA). The additional AOA is then used with the first AOA to determine the location of the second playback device relative to the first playback device in three dimensions (e.g., a position on the floor of the room as well as the height above the floor).

In some embodiments, the method 1700 further includes, while operating in the first playback configuration, playing back the one or more first channels of the multi-channel audio content in synchrony with playback of one or more second channels of the multi-channel audio content by the second playback device, as previously described. The one or more first channels may comprise at least one center channel and the one or more second channels may comprise at least one rear channel. In some embodiments, the method 1700 further includes identifying a second playback configuration for the second playback device to operate in based on the determined location of the second playback device relative to the first playback device and causing the second playback device to operate in the second playback configuration.

In some embodiments, the wireless radio of the first playback device (or a second wireless radio of the first playback device) may be used to transmit instructions to the second (or additional) playback devices. For example, the transmissions from the wireless radio may conform to an established format or specification that includes one or more fields for instructions that may be used for any suitable purpose. For example, the instructions may be used to identify playback configurations to be assigned to another playback device (e.g., telling another device that it is a right speaker or a left speaker and should therefore play back specified audio channels). As another example, the instructions may be used to set equalization values or volume levels for the other device.

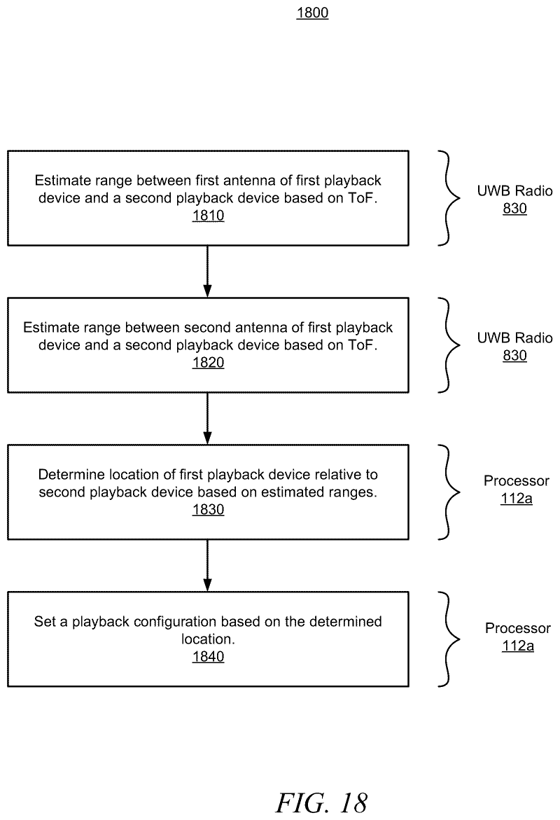

FIG. 18 shows an example embodiment of another method 1800 for a playback device employing a UWB radio to discriminate between other playback devices, based on ToF estimation techniques. Method 1800 can also be implemented by any of the playback devices (e.g., devices 200, 210, or 220) disclosed herein, individually or in combination with any of the computing systems disclosed herein, or any other computing system(s) and/or user device(s) now known or later developed.

Method 1800 begins at block 1810, which includes receiving a first signal at a first antenna of a wireless radio of a first playback device. The first signal may be transmitted from another (e.g., a second) playback device. Block 1810 further includes estimating a first range between the first antenna and the second playback device based on the first signal. In some embodiments, the estimation may be performed by the UWB radio.

At block 1820, method 1800 further includes receiving a second signal at a second antenna of the wireless radio of the first playback device. The second signal may be transmitted from the second playback device. Block 1820 further includes estimating a second range between the second antenna and the second playback device based on the second signal. In some embodiments, the estimation may be performed by the UWB radio. In some embodiments, the first range is between the first antenna and a first point on the second playback device and the second range is between the second antenna and a second point on the second playback device different from the first point.

At block 1830, method 1800 further includes determining a location of the first playback device relative to the second playback device based on the first range and the second range. In some embodiments, the determination may be performed by a processor of the first playback device.

At block 1840, method 1800 further includes after a determination of the location of the first playback device relative to the second playback device, operating in a first playback configuration where the first playback device plays back one or more first channels of multi-channel audio content. The process may be repeated for signals received from additional playback devices to determine the relative locations of third, fourth, etc. playback devices. In some embodiments, the playback configuration may be set by a processor of the first playback device and may be based on the determined location of the first playback device relative to the second playback device.

In some embodiments, the method 1800 further includes, while operating in the first playback configuration, playing back the one or more first channels of the multi-channel audio content in synchrony with playback of one or more second channels of the multi-channel audio content by the second playback device. In some embodiments, the multi-channel audio content is stereo content comprising a left channel and a right channel, and the one or more first channels comprises the left channel, and the one or more second channels comprise the right channel.

In some embodiments, the method 1800 further includes determining a time of flight of the first signal based on a timestamp encoded in the first signal and estimating the first range based on the time of flight.

In some embodiments, the method 1800 further includes identifying a difference in signal to noise ratio (SNR) between the first signal and the second signal and determining the location of the first playback device relative to the second playback device based on the difference in SNR.

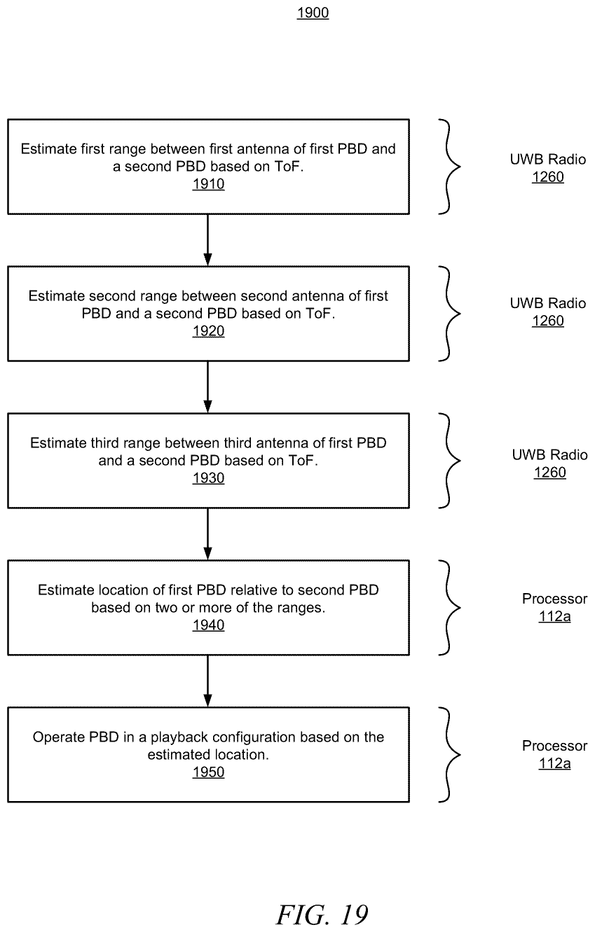

FIG. 19 shows an example embodiment of a method 1900 for a playback device employing a UWB radio to determine relative location to other playback devices, based on ToF estimation techniques in accordance with aspects of the disclosed technology. As discussed above, the ability to determine relative location to other playback devices can be used for a number of purposes including, for example, to automatically group nearby playback devices for synchronous playback, discriminate between left and right speakers in a stereo pair, allocate audio channels to those devices, perform acoustic tuning, provide synchronization between those devices, and/or facilitate setup of the audio system. For example, determining that a first playback device is located to the left of a second playback device enables the first playback device to be designated as a left speaker of a stereo pair and eliminates the need for a user to manually provide such information during system setup. Additionally, acoustic tuning, which may include the setting of equalization parameters, may depend on the locations of the playback devices. For example, the audio from a playback device which is located near a wall or in a corner of a room may benefit from specific equalization adjustments tailored to that location.

Method 1900 can be implemented by any of the playback devices (e.g., devices 1110, 1120, 1130, or 1160a, . . . 1160n) disclosed herein, individually or in combination with any of the computing systems (e.g., computing system(s) 106) and/or user devices (e.g., user devices 130) disclosed herein, or any other computing system(s) and/or user device(s) now known or later developed.

Method 1900 begins at block 1910, which includes receiving a first signal at a first antenna of a wireless radio of a first playback device. The first signal may be transmitted from another (e.g., a second) playback device. Block 1910 further includes estimating a first range between the first antenna and the second playback device based on a ToF of the first signal. In some embodiments, the estimation may be performed by the UWB radio.

At block 1920, method 1900 further includes receiving a second signal at a second antenna of the wireless radio of the first playback device. The second signal may be transmitted from the second playback device. Block 1920 further includes estimating a second range between the second antenna and the second playback device based on a ToF of the second signal. In some embodiments, the estimation may be performed by the UWB radio.

At block 1930, method 1900 further includes receiving a third signal at a third antenna of the wireless radio of the first playback device. The third signal may be transmitted from the second playback device. Block 1930 further includes estimating a third range between the third antenna and the second playback device based on a ToF of the third signal. In some embodiments, the estimation may be performed by the UWB radio. In some embodiments, the ToF of the first, second, and/or third signals is determined based on a timestamp encoded in the signals.

At block 1940, method 1900 further includes estimating a location of the first playback device relative to the second playback device based on two or more of the first range, the second range, and the third range. In some embodiments, the determination may be performed by a processor of the first playback device.

At block 1950, method 1900 further includes after an estimation of the location of the first playback device relative to the second playback device, operating in a playback configuration based on the estimated location. In some embodiments, the playback configuration may determine, for example, that the first playback device plays back in synchrony with the second playback device. Additionally (or alternatively), the playback configuration may determine which channels of multi-channel audio content the first playback device renders (e.g., alone or in synchrony with another playback device). The process may be repeated for signals received from additional playback devices to determine the relative locations of third, fourth, etc. playback devices. In some embodiments, the playback configuration may be set by a processor of the first playback device and may be based on the determined location of the first playback device relative to the second playback device.

In some embodiments, the method 1900 further includes, while operating in the playback configuration, playing back audio content in synchrony with playback audio content by the second playback device. In some embodiments, the first and second playback devices may render the same audio channels of the audio content in synchrony. In other embodiments, the first playback device may render one or more first channels of multi-channel audio content in synchrony with the second playback device rendering one or more second channels of the multi-channel audio content (e.g., that are different from the one or more first channels). For instance, the multi-channel audio content may be stereo content comprising a left channel and a right channel, and the one or more first channels comprise the left channel, and the one or more second channels comprise the right channel.

In some embodiments, the method 1900 further includes identifying a second playback configuration for the second playback device to operate in based on the determined location of the second playback device relative to the first playback device and causing the second playback device to operate in the second playback configuration.

In some embodiments, the wireless radio of the first playback device (or a second wireless radio of the first playback device) may be used to transmit instructions to the second (or additional) playback devices. For example, the transmissions from the wireless radio may conform to an established format or specification that includes one or more fields for instructions that may be used for any suitable purpose. For example, the instructions may be used to identify playback configurations to be assigned to another playback device (e.g., telling another device that it is a right speaker or a left speaker and should therefore play back specified audio channels). As another example, the instructions may be used to set equalization values or volume levels for the other device.

It should be appreciated that various alterations may be made to method 1900 without departing from the scope of the present disclosure. For example, one or more blocks and/or steps in method 1900 may be removed, reordered, and/or repeated. For instance, the playback device may capture less than three ranging measurements (e.g., two ranging measurements). In such a scenario, the playback device may omit at least one of block 1910, 1920, and/or 1930. Accordingly, the method 1900 may be altered in any of a variety of ways.

### VI. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

### VII. Example Features

(Feature 1) A first playback device comprising: a first antenna; a second antenna; a wireless radio coupled to the first antenna and the second antenna; at least one processor; at least one non-transitory computer-readable medium comprising program instructions that are executable by the at least one processor such that the first playback device is configured to: after receipt of a signal at the first antenna and the second antenna, measure a phase difference between the signal received at the first antenna and the signal received at the second antenna; estimate an angle of arrival of the signal to the first playback device based on the measured phase difference; determine a location of a second playback device relative to the first playback device based on the angle of arrival; and after a determination of the location of the second playback device relative to the first playback device, operate in a first playback configuration where the first playback device plays back one or more first channels of multi-channel audio content.
(Feature 2) The first playback device of feature 1, wherein a first receive port of the wireless radio is coupled to the first antenna, and wherein the first playback device further comprises a switch, and wherein the at least one non-transitory computer-readable medium further comprises program instructions that are executable by the at least one processor such that the first playback device is configured to control the switch to couple either a second receive port of the wireless radio or a transmit port of the wireless radio to the second antenna.
(Feature 3) The first playback device of feature 1, wherein the at least one non-transitory computer-readable medium further comprises program instructions that are executable by the at least one processor such that the first playback device is configured to: while operating in the first playback configuration, playback the one or more first channels of the multi-channel audio content in synchrony with play back of one or more second channels of the multi-channel audio content by the second playback device.
(Feature 4) The first playback device of feature 3, wherein the one or more first channels comprise at least one center channel and wherein the one or more second channels comprise at least one rear channel.
(Feature 5) The first playback device of feature 1, wherein the at least one non-transitory computer-readable medium further comprises program instructions that are executable by the at least one processor such that the first playback device is configured to: identify the playback configuration to operate in based on the determined location of the second playback device relative to the first playback device.
(Feature 6) The first playback device of feature 1, wherein the at least one non-transitory computer-readable medium further comprises program instructions that are executable by the at least one processor such that the first playback device is configured to: identify a second playback configuration for the second playback device to operate in based on the determined location of the second playback device relative to the first playback device; and cause the second playback device to operate in the second playback configuration.
(Feature 7) The first playback device of feature 6, wherein the wireless radio is a first wireless radio, wherein the first playback device further comprises a third antenna and a second wireless radio coupled to the third antenna, and wherein the program instructions that are executable by the at least one processor such that the first playback device is configured to cause the second playback device to operate in the second playback configuration comprises program instructions that are executable by the at least one processor such that the first playback device is configured to: transmit, using the second wireless radio, at least one instruction to the second playback device.
(Feature 8) The first playback device of feature 1, wherein the signal is a first signal and the at least one non-transitory computer-readable medium further comprises program instructions that are executable by the at least one processor such that the first playback device is configured to: after receipt of a second signal transmitted by a third playback device at the first antenna and the second antenna, determine a location of the third playback device relative to the first playback device based on the second signal.
(Feature 9) The first playback device of feature 8, wherein the at least one non-transitory computer-readable medium further comprises program instructions that are executable by the at least one processor such that the first playback device is configured to: while operating in the first playback configuration, playback the one or more first channels of the multi-channel audio content in synchrony with play back of one or more second channels of the multi-channel audio content by the second playback device and one or more third channels of the multi-channel audio content by the third playback device.
(Feature 10) The first playback device of feature 1, wherein the plurality of antennas further comprises a third antenna and wherein the at least one non-transitory computer-readable medium further comprises program instructions that are executable by the at least one processor such that the first playback device is configured to: after receipt of a second signal at the second antenna and the third antenna, estimate an angle of arrival of the second signal to the first playback device.
(Feature 11) The first playback device of feature 10, wherein the program instructions that are executable by the at least one processor such that the playback device is configured to determine the location of the second playback device relative to the first playback device comprises program instructions that are executable by the at least one processor such that the playback device is configured to: determine the location of the second playback device relative to the first playback device based on the angle of arrival of the first signal and the angle of arrival of the second signal.
(Feature 12) The first playback device of feature 10, wherein the first playback device further comprises a first switch and a second switch, and wherein the at least one non-transitory computer-readable medium further comprises program instructions that are executable by the at least one processor such that the first playback device is configured to: control the first switch to couple a first receive port of the wireless radio to either the second antenna or the third antenna; and control the second switch to couple either a second receive port of the wireless radio or a transmit port of the wireless radio to the first antenna.
(Feature 13) The first playback device of feature 1, wherein a polarization of the first antenna matches a polarization of the second antenna.
(Feature 14) The first playback device of feature 1, wherein polarization of at least one the first antenna or the second antenna is circular.
(Feature 15) The first playback device of feature 1, wherein at least one of the first antenna or the second antenna is a patch antenna.
(Feature 16) The first playback device of feature 1, wherein at least one of the first antenna or the second antenna is a directional antenna.
(Feature 17) The first playback device of feature 1, wherein the first antenna and the second antenna are separated by a distance that is less than one half of a wavelength corresponding to a center frequency of the signal.
(Feature 18) The first playback device of feature 1, wherein the wireless radio is an ultrawideband (UWB) radio and wherein the signal is a UWB signal.
(Feature 19) The first playback device of feature 1, wherein the at least one non-transitory computer-readable medium further comprises program instructions that are executable by the at least one processor such that the first playback device is configured to determine a location of a second playback device relative to the first playback device based on the angle of arrival and on a time of flight distance measurement.
(Feature 20) The first playback device of feature 1, wherein a timestamp is encoded in the signal and the at least one non-transitory computer-readable medium further comprises program instructions that are executable by the at least one processor such that the first playback device is configured to determine a range to the second playback device based on a time of flight calculation, the time of flight calculation based on the timestamp.
(Feature 21) The first playback device of feature 1, wherein the at least one non-transitory computer-readable medium further comprises program instructions that are executable by the at least one processor such that the first playback device is configured to: identify a volume level for a start of audio playback based on the range to the second playback device.
(Feature 22) The first playback device of feature 1, wherein the first playback device further comprises an input configured to receive the multi-channel audio content.
(Feature 23) The first playback device of feature 1, wherein the one or more processors include a first processor integrated into the wireless radio and a second processor that is separate and distinct from the wireless radio, and wherein the at least one non-transitory computer-readable medium comprises a first memory storing a first portion of the program instructions executed by the first processor and a second memory storing a second portion of the program instructions executed by the second processor.
(Feature 24) A method of operating a first playback device, the method comprising: after receipt of a signal at a first antenna and a second antenna of a wireless radio of the first playback device, measuring a phase difference between the signal received at the first antenna and the signal received at the second antenna; estimating an angle of arrival of the signal to the first playback device based on the measured phase difference; determining a location of a second playback device relative to the first playback device based on the angle of arrival; and after a determination of the location of the second playback device relative to the first playback device, operating in a first playback configuration where the first playback device plays back one or more first channels of multi-channel audio content.
(Feature 25) The method of feature 24, further comprising controlling a switch of the wireless radio to couple either a receive port of the wireless radio or a transmit port of the wireless radio to the second antenna.
(Feature 26) The method of feature 24, further comprising, while operating in the first playback configuration, playing back the one or more first channels of the multi-channel audio content in synchrony with playback of one or more second channels of the multi-channel audio content by the second playback device.
(Feature 27) The method of feature 26, wherein the one or more first channels comprise at least one center channel and wherein the one or more second channels comprise at least one rear channel.
(Feature 28) The method of feature 24, further comprising identifying the playback configuration to operate in based on the determined location of the second playback device relative to the first playback device.
(Feature 29) The method of feature 24, identifying a second playback configuration for the second playback device to operate in based on the determined location of the second playback device relative to the first playback device; and causing the second playback device to operate in the second playback configuration.
(Feature 30) The method of feature 29, wherein the wireless radio is a first wireless radio, wherein the first playback device comprises a third antenna and a second wireless radio coupled to the third antenna, the method further comprising transmitting, using the second wireless radio, at least one instruction to the second playback device.
(Feature 31) The method of feature 24, wherein the signal is a first signal, the method further comprising, after receipt of a second signal transmitted by a third playback device at the first antenna and the second antenna, determining a location of the third playback device relative to the first playback device based on the second signal.
(Feature 32) The method of feature 31, further comprising, while operating in the first playback configuration, playing back the one or more first channels of the multi-channel audio content in synchrony with play back of one or more second channels of the multi-channel audio content by the second playback device and one or more third channels of the multi-channel audio content by the third playback device.
(Feature 33) The method of feature 24, wherein the plurality of antennas further comprises a third antenna, the method further comprising, after receipt of a second signal at the second antenna and the third antenna, estimating an angle of arrival of the second signal to the first playback device.
(Feature 34) The method of feature 33, further comprising determining the location of the second playback device relative to the first playback device based on the angle of arrival of the first signal and the angle of arrival of the second signal.
(Feature 35) The method of feature 33, wherein the first playback device further comprises a first switch and a second switch, the method further comprising controlling the first switch to couple a first receive port of the wireless radio to either the second antenna or the third antenna; and controlling the second switch to couple either a second receive port of the wireless radio or a transmit port of the wireless radio to the first antenna.
(Feature 36) The method of feature 24, wherein a timestamp is encoded in the signal, the method further comprising determining a range to the second playback device based on a time of flight calculation, the time of flight calculation based on the timestamp.
(Feature 37) The method of feature 24, the method further comprising identifying a volume level for a start of audio playback based on the range to the second playback device.
(Feature 38) A first playback device comprising: a first antenna; a second antenna; a wireless radio coupled to the first antenna and the second antenna; at least one processor; at least one non-transitory computer-readable medium comprising program instructions that are executable by the at least one processor such that the first playback device is configured to: after receipt of a first signal at the first antenna from a second playback device, estimate a first range between the first antenna and the second playback device based on the first signal; after receipt of a second signal at the second antenna from the second playback device, estimate a second range between the second antenna and the second playback device based on the second signal; determine a location of the first playback device relative to the second playback device based on the first range and the second range; and after a determination of the location of the first playback device relative to the second playback device, operate in a first playback configuration where the first playback device plays back one or more first channels of multi-channel audio content.
(Feature 39) The first playback device of feature 38, wherein the first range is between the first antenna and a first point on the second playback device and the second range is between the second antenna and a second point on the second playback device different from the first point.
(Feature 40) The first playback device of feature 38, wherein the first playback device further comprises a first switch and a second switch, and wherein the at least one non-transitory computer-readable medium further comprises program instructions that are executable by the at least one processor such that the first playback device is configured to: control the first switch to couple either a receive port or a transmit port of the wireless radio through an output of the first switch to an input of the second switch; and to control the second switch to couple the output of the first switch to either the first antenna or the second antenna.
(Feature 41) The first playback device of feature 38, wherein the at least one non-transitory computer-readable medium further comprises program instructions that are executable by the at least one processor such that the first playback device is configured to: while operating in the first playback configuration, playback the one or more first channels of the multi-channel audio content in synchrony with play back of one or more second channels of the multi-channel audio content by the second playback device.
(Feature 42) The first playback device of feature 41, wherein the multi-channel audio content is stereo content comprising a left channel and a right channel, wherein the one or more first channels comprises the left channel, and wherein the one or more second channels comprise the right channel.
(Feature 43) The first playback device of feature 38, wherein the at least one non-transitory computer-readable medium further comprises program instructions that are executable by the at least one processor such that the first playback device is configured to: identify the first playback configuration to operate in based on the determined location of the first playback device relative to the second playback device.
(Feature 44) The first playback device of feature 38, wherein polarization of the first antenna matches a polarization of the second antenna.
(Feature 45) The first playback device of feature 38, wherein at least one of the first antenna or the second antenna is an omnidirectional antenna.
(Feature 46) The first playback device of feature 38, wherein at least one of the first antenna or the second antenna is a monopole antenna or an etched endfire array antenna.
(Feature 47) The first playback device of feature 38, wherein the wireless radio is an ultrawideband (UWB) radio and wherein the signal is a UWB signal.
(Feature 48) The first playback device of feature 38, wherein a timestamp is encoded in the first signal and wherein the program instructions that are executable by the at least one processor such that the first playback device is configured to estimate the first range comprises program instructions that are executable by the at least one processor such that the playback device is configured to: determine a time of flight of the first signal based on the timestamp; and estimate the first range based on the time of flight.
(Feature 49) The first playback device of feature 38, further comprising a parasitic element disposed between the first antenna and the second antenna.
(Feature 50) The first playback device of claim 49, wherein the parasitic element is configured to induce a directionally dependent difference in signal strength between the first antenna and the second antenna.
(Feature 51) The first playback device of claim 50, wherein the at least one non-transitory computer-readable medium further comprises program instructions that are executable by the at least one processor such that the first playback device is configured to employ the directionally dependent difference in signal strength in the determination of the location of the first playback device relative to the second playback device.
(Feature 52) The first playback device of feature 38, wherein the at least one non-transitory computer-readable medium further comprises program instructions that are executable by the at least one processor such that the first playback device is configured to identify a difference in signal to noise ratio (SNR) between the first signal and the second signal and determine the location of the first playback device relative to the second playback device based on the difference in SNR.
(Feature 53) The first playback device of feature 38, wherein the at least one non-transitory computer-readable medium further comprises program instructions that are executable by the at least one processor such that the first playback device is configured to transmit a third signal from the first antenna and a fourth signal from the second antenna.
(Feature 54) The first playback device of claim 53, wherein at least one of the third signal or the fourth signal comprises a timestamp.
(Feature 55) The first playback device of feature 38, wherein the program instructions that are executable by the at least one processor such that the first playback device is configured to estimate the first range comprises program instructions that are executable by the at least one processor such that the playback device is configured to: after receipt of a plurality of signals including the first signal from the second playback device at the first antenna, estimate the first range based on the first plurality of signals.
(Feature 56) The first playback device of feature 38, wherein the at least one non-transitory computer-readable medium further comprises program instructions that are executable by the at least one processor such that the first playback device is configured to: identify a volume level for a start of audio playback based on at least one of the first range or the second range.
(Feature 57) The first playback device of feature 38, wherein the one or more processors include a first processor integrated into the wireless radio and a second processor that is separate and distinct from the wireless radio, and wherein the at least one non-transitory computer-readable medium comprises a first memory storing a first portion of the program instructions executed by the first processor and a second memory storing a second portion of the program instructions executed by the second processor.
(Feature 58) A method of operating a first playback device, the method comprising: after receipt of a first signal, from a second playback device, at a first antenna of a wireless radio of the first playback device, estimating a first range between the first antenna and the second playback device based on the first signal; after receipt of a second signal, from the second playback device, at a second antenna of the wireless radio of the first playback device, estimating a second range between the second antenna and the second playback device based on the second signal; determining a location of the first playback device relative to the second playback device based on the first range and the second range; and after a determination of the location of the first playback device relative to the second playback device, operating in a first playback configuration where the first playback device plays back one or more first channels of multi-channel audio content.
(Feature 59) The method of claim 58, wherein the first range is between the first antenna and a first point on the second playback device and the second range is between the second antenna and a second point on the second playback device different from the first point.
(Feature 60) The method of claim 58, further comprising controlling a first switch of the first playback device to couple either a receive port or a transmit port of the wireless radio through an output of the first switch to an input of a second switch of the first playback device; and controlling the second switch to couple the output of the first switch to either the first antenna or the second antenna.
(Feature 61) The method of claim 58, further comprising, while operating in the first playback configuration, playing back the one or more first channels of the multi-channel audio content in synchrony with play back of one or more second channels of the multi-channel audio content by the second playback device.
(Feature 62) The method of claim 61, wherein the multi-channel audio content is stereo content comprising a left channel and a right channel, wherein the one or more first channels comprises the left channel, and wherein the one or more second channels comprise the right channel.
(Feature 63) The method of claim 58, further comprising identifying the first playback configuration to operate in based on the determined location of the first playback device relative to the second playback device.
(Feature 64) The method of claim 58, wherein a timestamp is encoded in the first signal, the method further comprising determining a time of flight of the first signal based on the timestamp; and estimating the first range based on the time of flight.
(Feature 65) The method of claim 58, wherein the first playback device comprises a parasitic element disposed between the first antenna and the second antenna, the parasitic element configured to induce a directionally dependent difference in signal strength between the first antenna and the second antenna, the method further comprising employing the directionally dependent difference in signal strength in the determination of the location of the first playback device relative to the second playback device.
(Feature 66) The method of claim 58, further comprising identifying a difference in signal to noise ratio (SNR) between the first signal and the second signal and determining the location of the first playback device relative to the second playback device based on the difference in SNR.
(Feature 67) The method of claim 58, further comprising transmitting a third signal from the first antenna and a fourth signal from the second antenna.
(Feature 68) The method of claim 67, wherein at least one of the third signal or the fourth signal comprises a timestamp.
(Feature 69) The method of claim 58, further comprising, after receipt of a plurality of signals including the first signal from the second playback device at the first antenna, estimating the first range based on the first plurality of signals.
(Feature 70) The method of claim 58, further comprising identifying a volume level for a start of audio playback based on at least one of the first range or the second range.
(Feature 71) A first playback device comprising: a first antenna; a second antenna; a third antenna; a wireless radio coupled to the first antenna, the second antenna, and the third antenna; at least one processor; and at least one non-transitory computer-readable medium comprising program instructions that are executable by the at least one processor such that the first playback device is configured to: after receipt of a first signal at the first antenna from a second playback device, estimate a first range between the first antenna and the second playback device based on time of flight (ToF) of the first signal; after receipt of a second signal at the second antenna from the second playback device, estimate a second range between the second antenna and the second playback device based on ToF of the second signal; after receipt of a third signal at the third antenna from the second playback device, estimate a third range between the third antenna and the second playback device based on ToF of the third signal; estimate a location of the first playback device relative to the second playback device based on two or more of the first range, the second range, and the third range; and after an estimation of the location of the first playback device relative to the second playback device, operate in a playback configuration based on the estimated location.
(Feature 72) The first playback device of feature 71, wherein the at least one non-transitory computer-readable medium further comprises program instructions that are executable by the at least one processor such that the first playback device is configured to: estimate the location of the first playback device relative to the second playback device using trilateration based on the estimated first range and the estimated second range; and employ the estimated third range to disambiguate the trilateration.
(Feature 73) The first playback device of feature 71 or 72, wherein the third antenna is associated with a greatest ToF from among the ToF of the first signal, the ToF of the second signal, and the ToF of the third signal.
(Feature 74) The first playback device of any of features 71-73, further comprising one or more switches configured to selectively couple one of the first antenna, the second antenna, or the third antenna to a port of the wireless radio through an electrical path.
(Feature 75) The first playback device of feature 74, wherein the at least one non-transitory computer-readable medium further comprises program instructions that are executable by the at least one processor such that the first playback device is configured to correct one or more of the ToF of the first signal, the ToF of the second signal, and the ToF of the third signal based on a calibrated electrical path length of the electrical path.
(Feature 76) The first playback device of any of features 71-75, wherein the estimated location is a first estimated location and the at least one non-transitory computer-readable medium further comprises program instructions that are executable by the at least one processor such that the first playback device is configured to: repeat the process to generate a second estimated location; and generate a refined estimated location based on a combination of the first estimated location and the second estimated location.
(Feature 77) The first playback device of feature 76, wherein the combination is an average of the first estimated location and the second estimated location.
(Feature 78) The first playback device of any of features 71-77, wherein the at least one non-transitory computer-readable medium further comprises program instructions that are executable by the at least one processor such that the first playback device is configured to: while operating in the playback configuration, playback the one or more first channels of multi-channel audio content in synchrony with play back of one or more second channels of the multi-channel audio content by the second playback device.
(Feature 79) The first playback device of feature 78, wherein the multi-channel audio content is stereo content comprising a left channel and a right channel, wherein the one or more first channels comprise the left channel, and wherein the one or more second channels comprise the right channel.
(Feature 80) The first playback device of any of features 71-79, wherein the at least one non-transitory computer-readable medium further comprises program instructions that are executable by the at least one processor such that the first playback device is configured to identify the playback configuration to operate in based on the determined location of the first playback device relative to the second playback device.
(Feature 81) The first playback device of any of features 71-80, wherein at least one of the first antenna, the second antenna, or the third antenna is an omnidirectional antenna.
(Feature 82) The first playback device of any of features 71-81, wherein the wireless radio is an ultrawideband (UWB) radio and wherein the first signal is a UWB signal.
(Feature 83) The first playback device of any of features 71-82, wherein a timestamp is encoded in the first signal and wherein the program instructions that are executable by the at least one processor such that the first playback device is configured to estimate the first range comprises program instructions that are executable by the at least one processor such that the playback device is configured to: determine the ToF of the first signal based on the timestamp; and estimate the first range based on the ToF.
(Feature 84) The first playback device of any of features 71-83, wherein the one or more processors include a first processor integrated into the wireless radio and a second processor that is separate and distinct from the wireless radio, and wherein the at least one non-transitory computer-readable medium comprises a first memory storing a first portion of the program instructions executed by the first processor and a second memory storing a second portion of the program instructions executed by the second processor.
(Feature 85) The first playback device of any of features 71-84, wherein the first antenna, the second antenna, and the third antenna are disposed on the device in a configuration that avoids the locating of conductive elements between the antennas.
(Feature 86) The first playback device of any of features 71-85, wherein the first antenna, the second antenna, and the third antenna are disposed on the device in locations that are selected to provide increased separation between the antennas.
(Feature 87) The first playback device of any of features 71-86, further comprising a Power-over-Ethernet interface configured to provide power to the first playback device.
(Feature 88) The first playback device of any of features 71-87, wherein the first playback device is disposed within an overhead fixture.
(Feature 89) An audio playback system comprising: a first playback device comprising a first antenna; a second antenna; a first wireless radio coupled to the first antenna and the second antenna; at least one processor; and at least one non-transitory computer-readable medium; and a second playback device comprising a third antenna; a second wireless radio coupled to the third antenna; one or more processors; and one or more non-transitory computer-readable media, wherein the one or more non-transitory computer-readable media comprises program instructions that are executable by the one or more processors such that the second playback device is configured to after receipt of a first signal at the third antenna from a third playback device, estimate a first range between the third antenna and the third playback device based on time of flight (ToF) of the first signal, and communicate the first range to the first playback device; and the at least one non-transitory computer-readable medium comprises program instructions that are executable by the at least one processor such that the first playback device is configured to after receipt of a second signal at the first antenna from the third playback device, estimate a second range between the first antenna and the third playback device based on ToF of the second signal, after receipt of a third signal at the second antenna from the third playback device, estimate a third range between the second antenna and the third playback device based on ToF of the third signal, after receipt of the first range from the second playback device, estimate a location of the first playback device relative to the third playback device based on two or more of the first range, the second range and the third range, and on the location of the first playback device relative to the second playback device, and after estimation of the location of the first playback device relative to the second playback device, operate in a playback configuration based on the estimated location.
(Feature 90) A method of operating a first playback device, the method comprising: after receipt of a first signal at a first antenna from a second playback device, estimating a first range between the first antenna and the second playback device based on time of flight (ToF) of the first signal; after receipt of a second signal at a second antenna from the second playback device, estimating a second range between the second antenna and the second playback device based on ToF of the second signal; after receipt of a third signal at a third antenna from the second playback device, estimating a third range between the third antenna and the second playback device based on ToF of the third signal; estimating a location of the first playback device relative to the second playback device based on two or more of the first range, the second range, and the third range; and after an estimation of the location of the first playback device relative to the second playback device, operating in a playback configuration based on the estimated location.
(Feature 91) The method of feature 90, further comprising: estimating the location of the first playback device relative to the second playback device using trilateration based on the estimated first range and the estimated second range; and employing the estimated third range to disambiguate the trilateration.
(Feature 92) The method of feature 90 or 91, wherein the third antenna is associated with a greatest ToF from among the ToF of the first signal, the ToF of the second signal, and the ToF of the third signal.
(Feature 93) The method of any of features 90-92, further comprising configuring one or more switches of the first playback device to selectively couple one of the first antenna, the second antenna, or the third antenna to a port of a wireless radio of the first playback device through an electrical path.
(Feature 94) The method of feature 93, wherein the wireless radio is an ultrawideband (UWB) radio and wherein the first signal is a UWB signal.
(Feature 95) The method of feature 93, further comprising correcting one or more of the ToF of the first signal, the ToF of the second signal, and the ToF of the third signal based on a calibrated electrical path length of the electrical path.
(Feature 96) The method of any of features 90-95, wherein the estimated location is a first estimated location, and the method further comprises: repeating the process to generate a second estimated location; and generating a refined estimated location based on a combination of the first estimated location and the second estimated location.
(Feature 97) The method of feature 96, wherein the combination is an average of the first estimated location and the second estimated location.
(Feature 98) The method of any of features 90-97, further comprising, while operating in the playback configuration, playing back the one or more first channels of multi-channel audio content in synchrony with playback of one or more second channels of the multi-channel audio content by the second playback device.
(Feature 99) The method of feature 98, wherein the multi-channel audio content is stereo content comprising a left channel and a right channel, wherein the one or more first channels comprise the left channel, and wherein the one or more second channels comprise the right channel.
(Feature 100) The method of any of features 90-99, further comprising identifying the playback configuration to operate in based on the determined location of the first playback device relative to the second playback device.
(Feature 101) The method of any of features 90-100, wherein at least one of the first antenna, the second antenna, or the third antenna is an omnidirectional antenna.
(Feature 102) The method of any of features 90-101, wherein a timestamp is encoded in the first signal, the method further comprising: determining the ToF of the first signal based on the timestamp; and estimating the first range based on the ToF.
(Feature 103) A method for estimating a position of a first playback device, the method comprising: after receipt of a first signal, from a second playback device, at a first antenna of the first playback device, estimating a first range between the first antenna and the second playback device based on the first signal; after receipt of a second signal, from the second playback device, at a second antenna of the first playback device, estimating a second range between the second antenna and the second playback device based on the second signal; estimating a location of the first playback device relative to the second playback device based on the first range and the second range; and based on the estimated location of the first playback device relative to the second playback device, operating in a first playback configuration.
(Feature 104) The method of feature 103, further comprising identifying the first playback configuration to operate in based on the determined location of the first playback device relative to the second playback device.
(Feature 105) The method of one of features 103 or 104, further comprising, after receipt of a third signal, from the second playback device, at a third antenna, estimating a third range between the third antenna and the second playback device, wherein estimating the location of the first playback device relative to the second playback device comprises estimating the location based on the first range, the second range, and the third range.
(Feature 106) The method of any of features 103 to 105, further comprising estimating at least one of the first range, the second range, and the third range based on a time of flight (ToF) of the first signal, the second signal, and/or the third signal, respectively.
(Feature 107) The method of one of features 105 or 106, further comprising: estimating the location of the first playback device relative to the second playback device using trilateration based on the estimated first range and the estimated second range; and employing the estimated third range to disambiguate the trilateration.
(Feature 108) The method of feature 107, wherein the third antenna is associated with a greatest ToF from among the ToF of the first signal, the ToF of the second signal, and the ToF of the third signal.
(Feature 109) The method of one of features 106 to 108, further comprising estimating a ToF of one or more of the first to third signals based on a timestamp encoded into the respective one or more of the first to third signals.
(Feature 110) The method of one of features 106 to 109, further comprising: configuring one or more switches of the first playback device to selectively couple one of the first antenna, the second antenna, or the third antenna to a port of a wireless radio of the first playback device through an electrical path; and correcting one or more of the ToF of the first signal, the ToF of the second signal, and the ToF of the third signal based on a calibrated electrical path length of the electrical path.
(Feature 111) The method of any of features 103 to 110, further comprising estimating the location of the first playback device relative to the second playback device based at least in part on a directionally dependent difference in signal strength between the first and second antennas induced by a parasitic element disposed between the first and second antennas.
(Feature 112) The method of any of features 103 to 111, further comprising estimating the location of the first playback device relative to the second playback device based at least in part on a difference in signal to noise ratio (SNR) between the first signal and the second signal.
(Feature 113) The method of any of features 103 to 112, wherein the first antenna and the second antenna are comprised by a wireless radio of the first playback device, the method further comprising controlling a first switch of the first playback device to couple either a receive port or a transmit port of the wireless radio through an output of the first switch to an input of a second switch of the first playback device; and controlling the second switch to couple the output of the first switch to either the first antenna or the second antenna.
(Feature 114) The method of any of features 103 to 113, wherein estimating the first range is based on a plurality of signals at the first antenna including the first signal.
(Feature 115) The first playback device of any of features 103 to 114, wherein at least one of the antennas is an omnidirectional antenna.
(Feature 116) The first playback device of any of features 103 to 115, wherein at least one of the antennas is a monopole antenna or an etched endfire array antenna.
(Feature 117) The first playback device of any of features 103 to 116, further comprising a Power-over-Ethernet interface configured to provide power to the first playback device.
(Feature 118) The first playback device of any of features 103 to 117, wherein the first playback device is disposed within an overhead fixture.
(Feature 119) A method of operating a first playback device comprising a plurality of antennas, the method comprising: after receipt of a signal at a first antenna and a second antenna of the plurality of antennas, measuring a phase difference between the signal received at the first antenna and the signal received at the second antenna; estimating an angle of arrival of the signal to the first playback device based on the measured phase difference; estimating a location of a second playback device relative to the first playback device based on the angle of arrival; and based on the estimated location of the second playback device relative to the first playback device, causing the first playback device to operate in a first playback configuration.
(Feature 120) The method of feature 119, further comprising, after receipt of a second signal at the second antenna and the third antenna of the plurality of antennas, estimating an angle of arrival of the second signal to the first playback device, wherein estimating the location of the second playback device relative to the first playback device is further based on the angle of arrival of the second signal.
(Feature 121) The method of feature 120, further comprising, after receipt of a third signal transmitted by a third playback device at the first antenna and the second antenna, determining a location of the third playback device relative to the first playback device based on the third signal.
(Feature 122) The method of one of features 119 to 121, wherein the first and second antennas are comprised by a first wireless radio, wherein the first playback device comprises a third antenna and a second wireless radio coupled to the third antenna, the method further comprising transmitting, using the second wireless radio, at least one instruction to the second playback device.
(Feature 123) The method of one of features 119 to 122, wherein at least one of the first antenna or the second antenna is a patch antenna or a directional antenna.
(Feature 124) The method of one of features 119 to 123, further comprising: controlling a switch of the wireless radio to couple either a receive port of the wireless radio or a transmit port of the wireless radio to the first antenna; and optionally further comprising controlling a second switch to couple either a second receive port of the wireless radio or a transmit port of the wireless radio to the second antenna.
(Feature 125) The method of any of features 119 to 124, wherein, in the first playback configuration, the first playback device plays back one or more first channels of multi-channel audio content.
(Feature 126) The method of feature 125, further comprising, while operating in the playback configuration, playing back the one or more first channels of multi-channel audio content in synchrony with playback of one or more second channels of the multi-channel audio content by the second playback device.
(Feature 127) The method of any of features 119 to 126, wherein the first playback device further comprises an input configured to receive the multi-channel audio content.
(Feature 128) The method of any of features 119 to 127, further comprising, based on the estimated location of the second playback device relative to the first playback device, causing the second playback device to operate in a second playback configuration.
(Feature 129) The method of any of features 119 to 128, further comprising identifying a volume level for a start of audio playback based on at least one of the first range or the second range.
(Feature 130) The method of any of features 119 to 129, wherein polarization of the first antenna matches a polarization of the second antenna.
(Feature 131) The method of any of features 119 to 130, wherein the wireless radio is an ultrawideband (UWB) radio and wherein the signal is a UWB signal.
(Feature 132) A first playback device comprising: at least first and second antennas; a wireless radio coupled to the first antenna and the second antenna; at least one processor; and at least one non-transitory computer-readable medium comprising program instructions that are executable by the at least one processor such that the first playback device is configured to perform the method of any preceding feature.
(Feature 133) The first playback device of feature 132, further comprising the third antenna.
(Feature 134) The first playback device of feature 132 or 133, wherein the at least one processor includes: a first processor integrated into the wireless radio; and a second processor that is separate and distinct from the wireless radio.
(Feature 135) The first playback device of one of features 132 to 134, wherein the antennas are disposed on the device in a configuration that avoids the locating of conductive elements between the antennas.
(Feature 136) The first playback device of one of features 132 to 135, wherein the antennas are disposed on the device in locations that are selected to provide increased separation between the antennas.
(Feature 137) An audio playback system comprising: the first playback device of feature 132, configured to perform the method of one of features 103 or 104; and a second playback device comprising: a third antenna, a second wireless radio coupled to the third antenna, and one or more processors configured to cause the second playback device to: after receipt of a third signal, from the second playback device, at the third antenna of the second playback device, estimate a third range between the third antenna and the first playback device, and communicate the estimated third range to the first playback device for use by the first playback device in estimating the location of the first playback device relative to the second playback device based on the first range, the second range, and the third range.

1-35. (canceled)

36. A first playback device comprising:
a first antenna;
a second antenna;
a wireless radio coupled to the first antenna and the second antenna;
at least one processor;
at least one non-transitory computer-readable medium comprising program instructions that are executable by the at least one processor such that the first playback device is configured to:
after receipt of a signal at the first antenna and the second antenna, measure a phase difference between the signal received at the first antenna and the signal received at the second antenna;
estimate an angle of arrival of the signal to the first playback device based on the measured phase difference;
determine a location of a second playback device relative to the first playback device based on the angle of arrival; and
after a determination of the location of the second playback device relative to the first playback device, operate in a first playback configuration, based on the determined location, where the first playback device plays back one or more first channels of multi-channel audio content.

37. The first playback device of claim 36, wherein the at least one non-transitory computer-readable medium further comprises program instructions that are executable by the at least one processor such that the first playback device is configured to:
while operating in the first playback configuration, playback the one or more first channels of the multi-channel audio content in synchrony with playback of one or more second channels of the multi-channel audio content by the second playback device.

38. The first playback device of claim 37, wherein the one or more first channels comprise at least one center channel and wherein the one or more second channels comprise at least one rear channel.

39. The first playback device of claim 36, wherein the at least one non-transitory computer-readable medium further comprises program instructions that are executable by the at least one processor such that the first playback device is configured to:
identify a second playback configuration for the second playback device to operate in based on the determined location of the second playback device relative to the first playback device; and
cause the second playback device to operate in the second playback configuration.

40. The first playback device of claim 39, wherein the wireless radio is a first wireless radio, wherein the first playback device further comprises a third antenna and a second wireless radio coupled to the third antenna, and wherein the program instructions that are executable by the at least one processor such that the first playback device is configured to cause the second playback device to operate in the second playback configuration comprises program instructions that are executable by the at least one processor such that the first playback device is configured to:
transmit, using the second wireless radio, at least one instruction to the second playback device.

41. The first playback device of claim 36, wherein the signal is a first signal and the at least one non-transitory computer-readable medium further comprises program instructions that are executable by the at least one processor such that the first playback device is configured to:
after receipt of a second signal transmitted by a third playback device at the first antenna and the second antenna, determine a location of the third playback device relative to the first playback device based on the second signal.

42. The first playback device of claim 41, wherein the at least one non-transitory computer-readable medium further comprises program instructions that are executable by the at least one processor such that the first playback device is configured to:
while operating in the first playback configuration, playback the one or more first channels of the multi-channel audio content in synchrony with playback of one or more second channels of the multi-channel audio content by the second playback device and one or more third channels of the multi-channel audio content by the third playback device.

43. The first playback device of claim 36, wherein the at least one non-transitory computer-readable medium further comprises program instructions that are executable by the at least one processor such that the first playback device is configured to:
identify a volume level for a start of audio playback based on the range to the second playback device.

44. A first playback device comprising:
a first antenna;
a second antenna;
a wireless radio coupled to the first antenna and the second antenna;
at least one processor;
at least one non-transitory computer-readable medium comprising program instructions that are executable by the at least one processor such that the first playback device is configured to:
after receipt of a signal at the first antenna and the second antenna, measure a phase difference between the signal received at the first antenna and the signal received at the second antenna;
estimate an angle of arrival of the signal to the first playback device based on the measured phase difference; and
determine a location of a second playback device relative to the first playback device based on the angle of arrival.

45. The first playback device of claim 44, wherein a first receive port of the wireless radio is coupled to the first antenna, and wherein the first playback device further comprises a switch, and wherein the at least one non-transitory computer-readable medium further comprises program instructions that are executable by the at least one processor such that the first playback device is configured to control the switch to couple either a second receive port of the wireless radio or a transmit port of the wireless radio to the second antenna.

46. The first playback device of claim 44, wherein the plurality of antennas further comprises a third antenna and wherein the at least one non-transitory computer-readable medium further comprises program instructions that are executable by the at least one processor such that the first playback device is configured to:
after receipt of a second signal at the second antenna and the third antenna, estimate an angle of arrival of the second signal to the first playback device; and
determine the location of the second playback device relative to the first playback device based on the angle of arrival of the first signal and the angle of arrival of the second signal.

47. The first playback device of claim 46, wherein the first playback device further comprises a first switch and a second switch, and wherein the at least one non-transitory computer-readable medium further comprises program instructions that are executable by the at least one processor such that the first playback device is configured to:
control the first switch to couple a first receive port of the wireless radio to either the second antenna or the third antenna; and
control the second switch to couple either a second receive port of the wireless radio or a transmit port of the wireless radio to the first antenna.

48. The first playback device of claim 44, wherein the first antenna and the second antenna are separated by a distance that is less than one half of a wavelength corresponding to a center frequency of the signal.

49. The first playback device of claim 44, wherein the wireless radio is an ultrawideband (UWB) radio and wherein the signal is a UWB signal.

50. A method of operating a first playback device, the method comprising:
after receipt of a signal at a first antenna and a second antenna of a wireless radio of the first playback device, measuring a phase difference between the signal received at the first antenna and the signal received at the second antenna;
estimating an angle of arrival of the signal to the first playback device based on the measured phase difference;
determining a location of a second playback device relative to the first playback device based on the angle of arrival; and
after a determination of the location of the second playback device relative to the first playback device, operating in a first playback configuration, based on the determined location, where the first playback device plays back one or more first channels of multi-channel audio content.

51. The method of claim 50, further comprising controlling a switch of the wireless radio to couple either a receive port of the wireless radio or a transmit port of the wireless radio to the second antenna.

52. The method of claim 50, further comprising, while operating in the first playback configuration, playing back the one or more first channels of the multi-channel audio content in synchrony with playback of one or more second channels of the multi-channel audio content by the second playback device.

53. The method of claim 50, further comprising identifying a second playback configuration for the second playback device to operate in based on the determined location of the second playback device relative to the first playback device; and causing the second playback device to operate in the second playback configuration.

54. The method of claim 50, wherein the signal is a first signal, the method further comprising, after receipt of a second signal transmitted by a third playback device at the first antenna and the second antenna, determining a location of the third playback device relative to the first playback device based on the second signal.

55. The method of claim 54, further comprising, while operating in the first playback configuration, playing back the one or more first channels of the multi-channel audio content in synchrony with play back of one or more second channels of the multi-channel audio content by the second playback device and one or more third channels of the multi-channel audio content by the third playback device.
